(19) United States
(12) Patent Application Publication
(10) Pub. No.: US 2020/0218004 A1
(43) Pub. Date: Jul. 9, 2020

(54) BACKLIGHT UNIT AND A DISPLAY INCLUDING THE SAME

(71) Applicant: SAMSUNG DISPLAY CO., LTD., Yongin-si (KR)

(72) Inventors: Byung Seo YOON, Hwaseong-si (KR); Kyung Min KIM, Hwaseong-si (KR)

(21) Appl. No.: 16/698,134

(22) Filed: Nov. 27, 2019

(30) Foreign Application Priority Data
Jan. 9, 2019 (KR) 10-2019-0002640

(51) Int. Cl. F21V 8/00; G02F 1/13357

(52) U.S. Cl. CPC G02B 6/0043; G02F 2001/133614; G02B 6/0091; G02F 1/1336

(57) ABSTRACT

A backlight unit including: a light guide plate; a wavelength conversion pattern disposed on a lower surface of the light guide plate; and a scattering pattern disposed on the lower surface of the light guide plate, wherein the wavelength conversion pattern and the scattering pattern do not overlap each other in a plan view.

### CROSS-REFERENCE TO RELATED APPLICATION

This application claims priority under 35 U.S.C. § 119 to Korean Patent Application No. 10-2019-0002640, filed on Jan. 9, 2019, in the Korean Intellectual Property Office, the disclosure of which is incorporated by reference herein in its entirety.

### TECHNICAL FIELD

The present inventive concept relates to a backlight unit and a display including the same.

### DESCRIPTION OF THE RELATED ART

A liquid crystal display receives light from a backlight assembly and displays an image. Some backlight assemblies include a light source and a light guide plate. The light guide plate receives light from the light source and guides the light toward a display panel. In some liquid crystal displays, the light source provides white light, and the white light is filtered by a color filter of the display panel to realize a color.

Research is being conducted on using a wavelength conversion film to improve image quality such as color reproducibility of a liquid crystal display. Generally, a blue light source is used as a light source, and a wavelength conversion film is disposed on a light guide plate to convert blue light into white light. However, when light emitted from the blue light source leaks through side surfaces of the light guide plate, it may be recognized as light leakage by a user, thereby degrading the quality of an image.

### SUMMARY

According to an exemplary embodiment of the present inventive concept, there is provided a backlight unit including: a light guide plate; a wavelength conversion pattern disposed on a lower surface of the light guide plate; and a scattering pattern disposed on the lower surface of the light guide plate, wherein the wavelength conversion pattern and the scattering pattern do not overlap each other in a plan view.

According to an exemplary embodiment of the present inventive concept, there is provided a backlight unit including: a light guide plate; a wavelength conversion pattern disposed on a first surface of the light guide plate; a passivation layer disposed on the wavelength conversion pattern and covering the wavelength conversion pattern; and a first scattering pattern which is disposed on a first surface of the passivation layer, wherein the wavelength conversion pattern and the first scattering pattern do not overlap each other in a plan view.

According to an exemplary embodiment of the present inventive concept, there is provided a backlight unit including: a light guide plate; a wavelength conversion pattern disposed on a first surface of the light guide plate; and a first scattering pattern disposed on a second surface of the light guide plate, wherein the wavelength conversion pattern and the first scattering pattern do not overlap each other in a plan view.

According to an exemplary embodiment of the present inventive concept, there is provided a display device including: a light guide plate which includes a first side surface, a second side surface opposite the first side surface, an upper surface connected to the first side surface and the second side surface, and a lower surface opposite the upper surface; a wavelength conversion pattern disposed on the upper surface of the light guide plate or the lower surface of the light guide plate; a scattering pattern disposed on the upper surface of the light guide plate or the lower surface of the light guide plate; a light source facing the first surface; and a display panel which overlaps the light guide plate, wherein the wavelength conversion pattern and the scattering pattern do not overlap each other in a plan view.

### BRIEF DESCRIPTION OF THE DRAWINGS

The above and other aspects of the present inventive concept will become more apparent by describing in detail exemplary embodiments thereof, with reference to the accompanying drawings in which:

FIG. 1 is a perspective view of a backlight unit according to an exemplary embodiment of the present inventive concept;

FIG. 2 is a plan view of the backlight unit of FIG. 1;

FIG. 3 is a cross-sectional view taken along line A1-A1′ of FIG. 2;

FIG. 4 is a cross-sectional view taken along line A2-A2′ of FIG. 2;

FIG. 5 is a cross-sectional view taken along line A3-A3′ of FIG. 2;

FIG. 6 illustrates relative arrangement densities of wavelength conversion patterns and scattering patterns according to a region;

FIGS. 7, 8 and 9 schematically illustrate optical characteristics of the wavelength conversion patterns and the scattering patterns;

FIG. 10 is a schematic cross-sectional view illustrating a wavelength conversion pattern to explain wavelength conversion by the wavelength conversion pattern;

FIGS. 11, 12, 13 and 14 illustrate an improvement of the color difference between a light incidence portion and a counter portion in a structure not including scattering patterns and a structure including the scattering patterns;

FIGS. 15, 16, 17 and 18 are cross-sectional views of a backlight unit according to an exemplary embodiment of the present inventive concept;

FIGS. 19, 20 and 21 are cross-sectional views of a backlight unit according to an exemplary embodiment of the present inventive concept;

FIGS. 22, 23 and 24 are cross-sectional views of a backlight unit according to an exemplary embodiment of the present inventive concept;

FIGS. 25, 26 and 27 are cross-sectional views of a backlight unit according to an exemplary embodiment of the present inventive concept;

FIGS. 28, 29 and 30 are cross-sectional views of a backlight unit according to an exemplary embodiment of the present inventive concept;

FIGS. 31, 32 and 33 are cross-sectional views of a backlight unit according to an exemplary embodiment of the present inventive concept;

FIGS. 34, 35, 36 and 37 are plan views of backlight units according to exemplary embodiments of the present inventive concept; and

FIG. 38 is a cross-sectional view of a display according to an exemplary embodiment of the present inventive concept.

### DETAILED DESCRIPTION OF THE EMBODIMENTS

Exemplary embodiments of the present inventive concept will be described more fully hereinafter with reference to the accompanying drawings. The present inventive concept may, however, be embodied in many different forms and should not be construed as being limited to the embodiments set forth herein. Like reference numerals may refer to like elements throughout the specification and accompanying drawings.

As used herein, the singular forms “a”, “an” and “the” are intended to include the plural forms as well, unless the context clearly indicates otherwise.

It will be understood that when an element or layer is referred to as being “on”, “connected to” or “coupled to” another element or layer, it can be directly on, connected or coupled to the other element or layer or intervening elements or layers may be present.

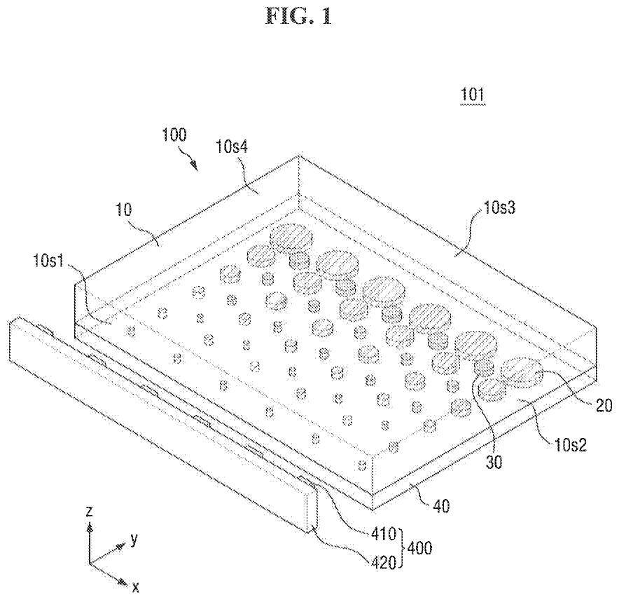

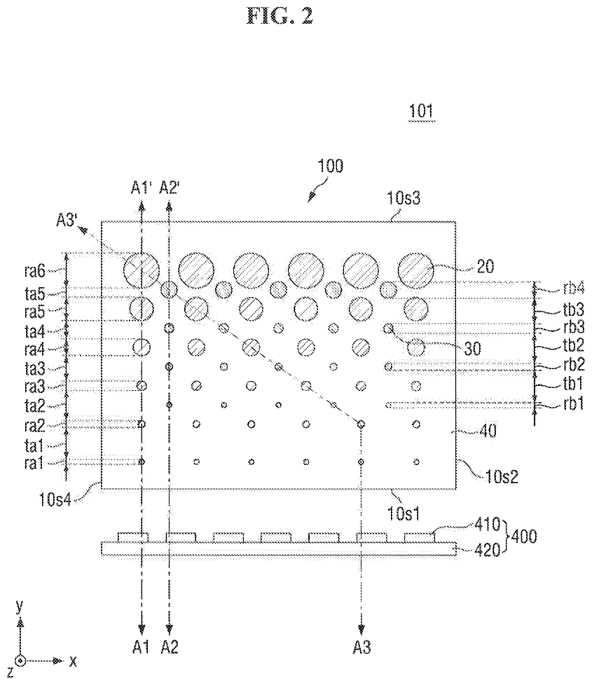

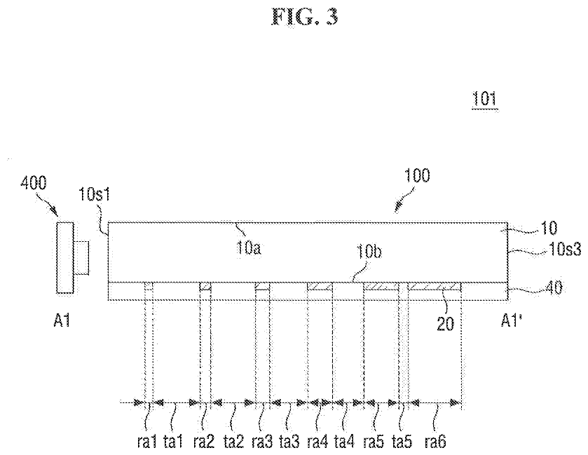

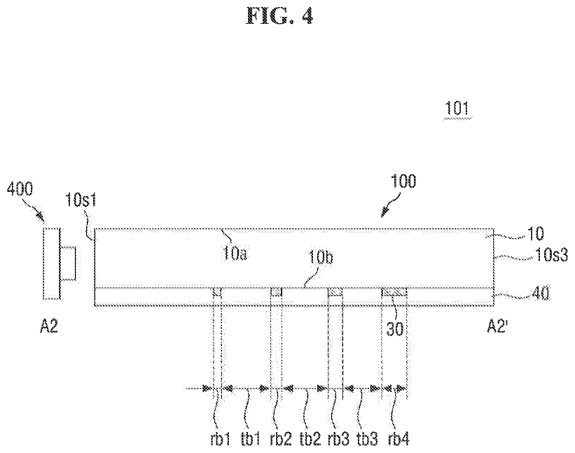

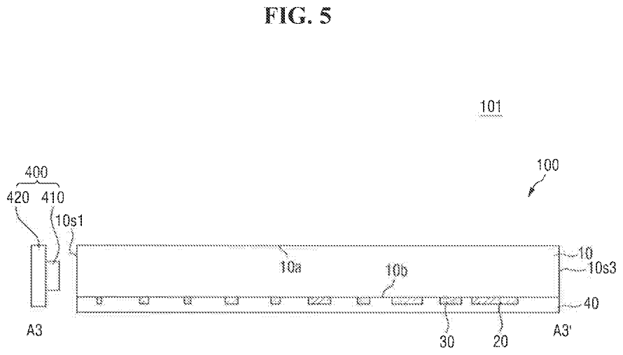

FIG. 1 is a perspective view of a backlight unit 101 according to an exemplary embodiment of the present inventive concept. FIG. 2 is a plan view of the backlight unit 101 of FIG. 1. FIG. 3 is a cross-sectional view taken along line A1-A1′ of FIG. 2. FIG. 4 is a cross-sectional view taken along line A2-A2′ of FIG. 2. FIG. 5 is a cross-sectional view taken along line A3-A3′ of FIG. 2.

Referring to FIGS. 1 through 5, the backlight unit 101 includes an optical member 100 and a light source 400. The optical member 100 may include a light guide plate 10, wavelength conversion patterns 20, scattering patterns 30, and a passivation layer 40.

The light guide plate 10 guides the path of light. The light guide plate 10 may be shaped like a polygonal column. The planar shape of the light guide plate 10 may be, but is not limited to, a rectangular shape. In an exemplary embodiment of the present inventive concept, the light guide plate 10 may be shaped like a hexagonal column having a substantially rectangular planar shape and may include an upper surface 10a, a lower surface 10b, and four side surfaces 10s (10s1, 10s2, 10s3 and 10s4). In a case where it is necessary to distinguish the four side surfaces from each other in this specification and the accompanying drawings, the four side surfaces will be indicated by ‘10s1,’ ‘10s2,’ ‘10s3,’ and ‘10s4.’ However, when a side surface is simply mentioned, it will be indicated by ‘10s.’

In an exemplary embodiment of the present inventive concept, each of the upper surface 10a and the lower surface 10b of the light guide plate 10 may be located in one plane, and the plane in which the upper surface 10a is located and the plane in which the lower surface 10b is located may be substantially parallel to each other such that the overall thickness of the light guide plate 10 is uniform. However, the upper surface 10a or the lower surface 10b can be composed of a plurality of planes, or the plane in which the upper surface 10a is located and the plane in which the lower surface 10b is located can intersect each other. For example, the light guide plate 10, like a wedge-type light guide plate, may become thinner from a first side surface (e.g., a light incidence surface) toward a second side surface (e.g., a counter surface) opposite the first side surface. Alternatively, the lower surface 10b may, up to a specific point, slope upward from a first side surface (e.g., the light incidence surface) toward a second side surface (e.g., the counter surface) opposite the first side surface such that the light guide plate 10 becomes thinner, and then, the upper surface 10a and the lower surface 10b may be flat.

The plane in which the upper surface 10a and/or the lower surface 10b is located may be at an angle of about 90 degrees to a plane in which each side surface 10s is located. In exemplary embodiments of the present inventive concept, the light guide plate 10 may include an inclined surface between the upper surface 10a and each side surface 10s and/or between the lower surface 10b and each side surface 10s. In other words, the light guide plate 10 may include a chamfer formed by cutting off each corner. The chamfer reduces the sharpness of each corner portion of the light guide plate 10, thereby preventing damage due to external impact. A case where the upper surface 10a and each side surface 10s meet directly at an angle of 90 degrees without the inclined surface therebetween will be described below, but the present inventive concept is not limited thereto.

In an example of the optical member 100, the light source 400 may be disposed adjacent to at least one side surface 10s of the light guide plate 10. In the drawings, a plurality of light-emitting diode (LED) light sources 410 mounted on a printed circuit board 420 are disposed adjacent to a side surface 10s1 at one long side of the light guide plate 10. However, the present inventive concept is not limited to this case. For example, the LED light sources 410 may be disposed adjacent to side surfaces 10s1 and 10s3 at both long sides or may be disposed adjacent to a side surface 10s2 or 10s4 at one short side or both of the side surfaces 10s2 and 10s4 at both short sides. In the embodiment of FIG. 1, the side surface 10s1 at one long side of the light guide plate 10 to which the light source 400 is disposed adjacent may be a light incidence surface on which light of the light source 400 is directly incident. In addition, the side surface 10s3 at the other long side which faces the side surface 10s1 may be a counter surface.

A first direction x may indicate a direction parallel to the light incidence surface 10s1 and the counter surface 10s3 in a plan view, and a second direction y may indicate a direction perpendicular to the light incidence surface 10s 1 and the counter surface 10s3 in the plan view. For example, the first direction x may indicate the longitudinal direction of both long sides 10s1 and 10s3 of the light guide plate 10, and the second direction y may indicate the longitudinal direction of both short sides 10s2 and 10s4 of the light guide plate 10. In addition, a third direction z may be a direction perpendicular to the first direction x and the second direction y, for example, the height direction of the light guide plate 10.

The LED light sources 410 may emit blue light. In other words, light emitted from the LED light sources 410 may be light having a blue wavelength band. In an exemplary embodiment of the present inventive concept, the wavelength band of blue light emitted from the LED light sources 410 may be 400 nm to 500 nm. The blue light emitted from the LED light sources 410 may enter the light guide plate 10 through the light incidence surface 10s1.

The light guide plate 10 may include an inorganic material. For example, the light guide plate 10 may be made of glass. In exemplary embodiments of the present inventive concept, the light guide plate 10 may include an organic material. For example, the light guide plate 10 may be made of poly(methyl methacrylate) (PMMA).

Light emitted from the light source 400 to the light incidence surface 10s 1 of the light guide plate 10 may be guided from the light incidence surface 10s1 toward the counter surface 10s3 by the light guide plate 10. To guide the incident light, total internal reflection may be induced to occur on the upper surface 10a and the lower surface 10b of the light guide plate 10. One of the conditions under which total internal reflection can occur in the light guide plate 10 is that a refractive index of the light guide plate 10 is greater than a refractive index of a medium that forms an optical interface with the light guide plate 10. As the refractive index of the medium that forms the optical interface with the light guide plate 10 is lower, a total reflection critical angle becomes smaller, leading to more total internal reflections.

For example, in a case where the light guide plate 10 is made of glass having a refractive index of about 1.5, sufficient total reflection may occur on the upper surface 10a of the light guide plate 10 because the upper surface 10a is exposed to an air layer having a refractive index of about 1 and forms an optical interface with the air layer. In addition, although the passivation layer 40 (to be described later) is laminated on the lower surface 10b of the light guide plate 10, the passivation layer 40 has a very small thickness compared with reset of the light guide plate 10, has a refractive index similar to or greater than that of the light guide plate 10, and forms an optical interface with the air layer by being exposed to the air layer. Therefore, sufficient total reflection may also occur on the lower surface 10b of the light guide plate 10.

The wavelength conversion patterns 20 and the scattering patterns 30 may be disposed on the lower surface 10b of the light guide plate 10.

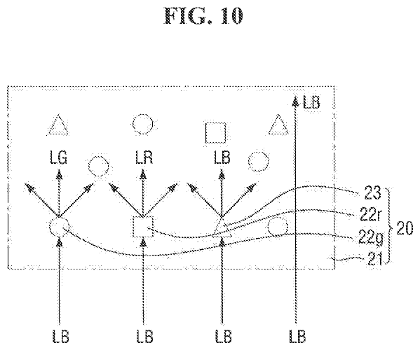

FIG. 10 is a schematic cross-sectional view illustrating the inside of a wavelength conversion pattern 20 to explain wavelength conversion by the wavelength conversion pattern 20.

Referring to FIG. 10, the wavelength conversion pattern 20 converts the wavelength of at least a portion of incident light. The wavelength conversion pattern 20 may include a binder 21 and wavelength conversion particles 22 dispersed in the binder 21. The wavelength conversion pattern 20 may further include scattering particles 23 dispersed in the binder 21, in addition to the wavelength conversion particles 22.

The binder 21 is a medium in which the wavelength conversion particles 22 are dispersed and may be made of various resin compositions. However, the present inventive concept is not limited to this case, and any medium in which the wavelength conversion particles 22 and/or the scattering particles 23 can be dispersed can be the binder 21 regardless of its name, additional functions, material, and the like.

The wavelength conversion particles 22 are particles that convert the wavelength of incident light. For example, the wavelength conversion particles 22 may be quantum dots, a fluorescent material, or a phosphorescent material. A case where the wavelength conversion particles 22 are quantum dots will be described below as an example.

For example, a quantum dot is a material having a crystal structure of several nanometers in size. The quantum dot is composed of several hundreds to thousands of atoms and exhibits a quantum confinement effect in which an energy band gap increases due to the small size of the quantum dot. When light of a wavelength having a higher energy than a hand gap is incident on the quantum dot, the quantum dot is excited by absorbing the light and fails to a ground state while emitting light of a specific wavelength. The emitted light of the specific wavelength has a value corresponding to the band gap. Emission characteristics of the quantum dot due to the quantum confinement effect can be controlled by controlling the size and composition of the quantum dot.

The quantum dot may include at least one of, for example, a group II-VI compound, a group II-V compound, a group III-VI compound, a group III-V compound, a group IV-VI compound, a group I-III-VI compound, a group II-IV-VI compound, and a group II-IV-V compound.

The quantum dot may include a core and a shell overcoating the core. The core may be, but is not limited to, at least one of, for example, CdS, CdSe, CdTe, ZnS, ZnSe, ZnTe, GaN, GaP, GaAs, GaSb, AlN, AlP, AlAs, AlSb, InP, InAs, InSb, SiC, Ca, Se, In, P, Fe, Pt, Ni, Co, Al, Ag, Au, Cu, FePt, Fe2O3, Fe3O4, Si, and Ge. The shell may include, but is not limited to, at least one of, for example, ZnS, ZnSe, ZnTe, CdS, CdSe, CdTe, HgS, HgSe, HgTe, AlN, AlP, AlAs, AlSb, GaN, GaP, GaAs, GaSb, GaSe, InN, InP, InAs, InSb, TlN, TlP, TlAs, TiSb, PbS, PbSe, and PbTe.

The wavelength conversion particles 22 may include a plurality of wavelength conversion particles 22 that convert incident light into different wavelengths. For example, the wavelength conversion particles 22 may include first wavelength conversion particles 22g that convert incident light of a specific wavelength into light of a first wavelength and emit the light of the first wavelength. In addition, the wavelength conversion particles 22 may include second wavelength conversion particles 22r that convert the incident light of the specific wavelength into light of a second wavelength and emit the light of the second wavelength. In an exemplary embodiment of the present inventive concept, light emitted from the light source 400 and then incident on the wavelength conversion particles 22 may be light of a blue wavelength, the first wavelength may be a green wavelength, and the second wavelength may be a red wavelength. For example, the blue wavelength may be a wavelength having a peak at 420 nm to 470 nm, the green wavelength may be a wavelength having a peak at 520 nm to 570 nm, and the red wavelength may be a wavelength having a peak at 620 nm to 670 nm. However, it should be understood that the blue, green and red wavelengths are not limited to the above example and include all wavelength ranges that can be recognized as blue, green and red.

In the above exemplary embodiment, when blue light LB incident on the wavelength conversion pattern 20 passes through the wavelength conversion pattern 20, a first portion of the blue light LB may be incident on the first wavelength conversion particles 22g to be converted into the green wavelength and emitted as light LG of the green wavelength, a second portion of the blue light LB may be incident on the second wavelength conversion particles 22r to be converted into the red wavelength and emitted as light LR of the red wavelength, and a third portion of the blue light LB may be emitted as it is without entering the first and second wavelength conversion particles 22g and 22r. Therefore, light that has passed through the wavelength conversion pattern 20 includes all of the light LB of the blue wavelength, the light LG of the green wavelength, and the light LR of the red wavelength. If the ratio of the emitted light of the different wavelengths is appropriately adjusted, white light or light of other colors can be displayed. The light converted by the wavelength conversion pattern 20 is concentrated in a narrow range of specific wavelengths and has a sharp spectrum with a narrow full width at half maximum (FWHM). Therefore, when the light of such a spectrum is filtered using a color filter to realize a color, color reproducibility can be improved.

Unlike that shown in the above exemplary embodiment, incident light may be light having a short wavelength such as ultraviolet light, and three types of wavelength conversion particles 22 for converting the incident light into the blue, green and red wavelengths may be disposed in the wavelength conversion pattern 20 to emit white light.

The wavelength conversion pattern 20 may further include the scattering particles 23. The scattering particles 23 may be non-quantum dot particles without a wavelength conversion function. The scattering particles 23 may scatter incident light to cause more of the incident light to enter the first and second wavelength conversion particles 22g and 22r. In addition, the scattering particles 23 may control an output angle of light for each wavelength to be uniform. For example, when a portion of incident light which enters the first and second wavelength conversion particles 22g and 22r is emitted after its wavelength is converted by the first and second wavelength conversion particles 22g and 22r, the emission direction of the portion of the incident light has random scattering characteristics. If there are no scattering particles 23 in the wavelength conversion pattern 20, the green and red wavelengths emitted after colliding with the first and second wavelength conversion particles 22g and 22r may have scattering emission characteristics, but the blue wavelength emitted without colliding with the first and second wavelength conversion particles 22g and 22r may not have the scattering emission characteristics. Therefore, the emission amount of the blue/green/red wavelength will vary according to the output angle. The scattering particles 23 may give the scattering emission characteristics to the blue wavelength even though it is emitted without colliding with the first and second wavelength conversion particles 22g and 22r, thereby controlling the output angle of light for each wavelength to be similar. The scattering particles 23 may be made of TiO₂ or SiO₂.

Referring back to FIGS. 1 through 5, the wavelength conversion patterns 20 may be disposed on the entire lower surface 10b of the light guide plate 10 and contact the lower surface 10b of the light guide plate 10. For example, rows and columns of wavelength conversion patterns 20 may be disposed on the lower surface 10b of the light guide plate 10. Although a total of 36 wavelength conversion patterns 20 are arranged in six wavelength conversion pattern rows and six wavelength conversion pattern columns in FIG. 1, this is merely exemplary, and the present inventive is not limited to this arrangement. In other words, a larger number of wavelength conversion patterns 20 can be arranged in more rows and more columns.

Although the wavelength conversion patterns 20 have a circular planar shape in the drawings, the planar shape of the wavelength conversion patterns 20 is not limited to the circular shape and may also be a polygonal shape such as a quadrangle or a triangle.

The wavelength conversion patterns 20 may be arranged regularly along the first direction x. However, the arrangement of the wavelength conversion patterns 20 is not limited to this arrangement, and the wavelength conversion patterns 20 may also be arranged irregularly. To uniformly convert light incident into the light guide plate 10, the wavelength conversion patterns 20 may be arranged at similar densities along the first direction x. In other words, wavelength conversion pattern columns formed by the wavelength conversion patterns 20 may be spaced apart from each other by about the same distance. However, the present inventive concept is not limited to this case.

The wavelength conversion patterns 20 may be arranged at different densities along the second direction y. For example, the arrangement density of the wavelength conversion patterns 20 may be low in a region adjacent to the light incidence surface 10s1 to which a relatively large amount of light is provided and may be high in a region adjacent to the counter surface 10s3 to which a relatively small amount of light is provided. The arrangement density may be adjusted using the area and interval of each wavelength conversion pattern 20. For example, the area of each wavelength conversion pattern 20 in the region adjacent to the light incidence surface 10s1 may be small, and the area of each wavelength conversion pattern 20 in the region adjacent to the counter surface 10s3 may be large. If the arrangement density is adjusted using the area of each wavelength conversion pattern 20, the area of each wavelength conversion pattern 20 may increase from the light incidence surface 10s1 toward the counter surface 10s3.

For example, if a row formed by the wavelength conversion patterns 20 disposed closest to the light incidence surface 10s1 is a first wavelength conversion pattern row, a second wavelength conversion pattern row, a third wavelength conversion pattern row, a fourth wavelength conversion pattern row, a fifth wavelength conversion pattern row, and a sixth wavelength conversion pattern row may be sequentially defined from the light incidence surface 10s1 toward the counter surface 10s3. The area of each wavelength conversion pattern 20 may increase sequentially in the order of an area ra1 of each wavelength conversion pattern 20 located in the first wavelength conversion pattern row, an area ra2 of each wavelength conversion pattern 20 located in the second wavelength conversion pattern row, an area ra3 of each wavelength conversion pattern 20 located in the third wavelength conversion pattern row, an area ra4 of each wavelength conversion pattern 20 located in the fourth wavelength conversion pattern row, an area ra5 of each wavelength conversion pattern 20 located in the fifth wavelength conversion pattern row, and an area ra6 of each wavelength conversion pattern 20 located in the sixth wavelength conversion pattern row.

In addition, the wavelength conversion patterns 20 may be arranged at different intervals along the second direction y. The interval between the wavelength conversion patterns 20 may be reduced from the light incidence surface 10s1 toward the counter surface 10s3.

For example, an interval ta1 between the wavelength conversion patterns 20 located in the first wavelength conversion pattern row and the wavelength conversion patterns 20 located in the second wavelength conversion pattern row may be largest, and an interval ta5 between the wavelength conversion patterns 20 located in the fifth wavelength conversion pattern row and the wavelength conversion patterns 20 located in the sixth wavelength conversion pattern row may be smallest. In other words, the interval between the wavelength conversion patterns 20 may decrease sequentially in the order of the interval ta1 between the wavelength conversion patterns 20 located in the first wavelength conversion pattern row and the wavelength conversion patterns 20 located in the second wavelength conversion pattern row, an interval ta2 between the wavelength conversion patterns 20 located in the second wavelength conversion pattern row and the wavelength conversion patterns 20 located in the third wavelength conversion pattern row, an interval ta3 between the wavelength conversion patterns 20 located in the third wavelength conversion pattern row and the wavelength conversion patterns 20 located in the fourth wavelength conversion pattern row, an interval ta4 between the wavelength conversion patterns 20 located in the fourth wavelength conversion pattern row and the wavelength conversion patterns 20 located in the fifth wavelength conversion pattern row, and the interval ta5 between the wavelength conversion patterns 20 located in the fifth wavelength conversion pattern row and the wavelength conversion patterns 20 located in the sixth wavelength conversion pattern row.

Therefore, the arrangement density of the wavelength conversion patterns 20 may be increased from the light incidence surface 10s1 toward the counter surface 10s3 by adjusting the area and interval of each wavelength conversion pattern 20.

The arrangement density of the wavelength conversion patterns 20 is adjusted not just using the area and interval of each wavelength conversion pattern 20 as described above. In an exemplary embodiment of the present inventive concept, the arrangement density may also be adjusted by placing a larger number of wavelength conversion patterns 20 of the same size from the light incidence surface 10s1 toward the counter surface 10s3.

In addition, it is possible to obtain the same effect as adjusting the arrangement density by adjusting light conversion efficiency using the concentration of wavelength conversion particles included in the wavelength conversion patterns 20.

The thickness of the wavelength conversion patterns 20 may be about 10 μm to 50 μm. In an exemplary embodiment of the present inventive concept, the thickness of the wavelength conversion patterns 20 may be about 15 μm.

The wavelength conversion patterns 20 may be formed by a method such as coating. For example, the wavelength conversion patterns 20 may be formed by slit-coating a wavelength conversion composition on the lower surface 10b of the light guide plate 10 and drying and curing the wavelength conversion composition. However, the method of forming the wavelength conversion patterns 20 is not limited to the above example, and various other lamination methods can be used.

A barrier layer may be further disposed between the wavelength conversion patterns 20 and the light guide plate 10. The barrier layer may cover the entire lower surface 10b of the light guide plate 10. Side surfaces of the barrier layer may be aligned with the side surfaces 10s of the light guide plate 10. The wavelength conversion patterns 20 are formed to contact the barrier layer. Like the passivation layer 40 to be described later, the barrier layer prevents the penetration of moisture and/or oxygen (hereinafter, referred to as ‘moisture/oxygen’). The barrier layer may include an inorganic material. For example, the barrier layer may be made of silicon nitride, aluminum nitride, zirconium nitride, titanium nitride, hafnium nitride, tantalum nitride, silicon oxide, aluminum oxide, titanium oxide, tin oxide, cerium oxide, silicon oxynitride, or a metal thin film having a secured light transmittance. The barrier layer may be made of, but is not limited to, the same material as the passivation layer 40. The barrier layer may be formed by a deposition method such as chemical vapor deposition.

The scattering patterns 30 may be disposed on the lower surface 10b of the light guide plate 10. The scattering patterns 30 serve as light outputting patterns that change the angle of light propagating inside the light guide plate 10 through total reflection and output the light having the changed angle to the light guide plate 10 disposed thereabove.

In an exemplary embodiment of the present inventive concept, the scattering patterns 30 may be provided as a separate layer or separate patterns. For example, a pattern layer including protruding patterns and/or concave groove patterns may be formed on the lower surface 10b of the light guide plate 10, or printed patterns may be formed on the lower surface 10b of the light guide plate 10 to function as the scattering patterns 30. In an exemplary embodiment of the present inventive concept, the scattering patterns 30 may be formed of the surface shape of the light guide plate 10 itself. For example, concave grooves may be formed in the lower surface 10b of the light guide plate 10 to function as the scattering patterns 30.

When the scattering patterns 30 are provided as separate patterns, they may include a binder and scattering particles disposed in the binder, like the wavelength conversion patterns 20. The binder and the scattering particles may be the same as or similar to the above-described binder and scattering particles of the wavelength conversion patterns 20, and thus, a detailed description thereof will be omitted. In exemplary embodiments of the present inventive concept, the scattering patterns 30 may be wavelength conversion patterns 20 that do not include wavelength conversion particles.

The scattering patterns 30 may be disposed on the entire lower surface 10b of the light guide plate 10 to contact the lower surface 10b of the light guide plate 10. For example, rows and columns of the scattering patterns 30 may be disposed on the lower surface 10b of the light guide plate 10. Although a total of 20 scattering patterns 30 are arranged in four scattering pattern rows and five scattering pattern columns in FIG. 1, this is merely an example arrangement, and the present inventive concept is not limited to this arrangement. In other words, a larger number of scattering patterns 30 can be arranged in rows and columns.

Although the scattering patterns 30 have a circular planar shape in the drawings, the planar shape of the scattering patterns 30 is not limited to the circular shape and may also be a polygonal shape such as a quadrangle or a triangle.

The scattering patterns 30 may be arranged regularly along the first direction x. However, the arrangement of the scattering patterns 30 is not limited to this arrangement, and the scattering patterns 30 may also be arranged irregularly. To supply light uniformly to above the light guide plate 10, the scattering patterns 30 may be arranged at similar densities along the first direction x. In other words, scattering pattern columns formed by the scattering patterns 30 may be spaced apart from each other by the same distance. However, the present inventive concept is not limited to this case.

The scattering patterns 30 may be arranged at different densities along the second direction y. For example, the arrangement density of the scattering patterns 30 may be low in a region adjacent to the light incidence surface 10s1 to which a relatively large amount of light is provided and may be high in a region adjacent to the counter surface 10s3 to which a relatively small amount of light is provided. The arrangement density may be adjusted using the area and interval of each scattering pattern 30. For example, the area of each scattering pattern 30 in the region adjacent to the light incidence surface 10s1 may be small, and the area of each scattering pattern 30 in the region adjacent to the counter surface 10s3 may be large. If the arrangement density is adjusted using the area of each scattering pattern 30, the area of each scattering pattern 30 may increase from the light incidence surface 10s1 toward the counter surface 10s3.

For example, if a row formed by the scattering patterns 30 disposed closest to the light incidence surface 10s1 is a first scattering pattern row, a second scattering pattern row, a third scattering pattern row, and a fourth scattering pattern row may be sequentially arranged from the light incidence surface 10s1 toward the counter surface 10s3. The area of each scattering pattern 30 may increase sequentially in the order of an area rb1 of each scattering pattern 30 located in the first scattering pattern row, an area rb2 of each scattering pattern 30 located in the second scattering pattern row, an area rb3 of each scattering pattern 30 located in the third scattering pattern row, and an area rb4 of each scattering pattern 30 located in the fourth scattering pattern row.

In addition, the scattering patterns 30 may be arranged at different intervals along the second direction y. The interval between the scattering patterns 30 may be reduced from the light incidence surface 10s1 toward the counter surface 10s3.

For example, the interval between the scattering patterns 30 may decrease sequentially in the order of an interval tb1 between the scattering patterns 30 located in the first scattering pattern row and the scattering patterns 30 located in the second scattering pattern row, an interval tb2 between the scattering patterns 30 located in the second scattering pattern row and the scattering patterns 30 located in the third scattering pattern row, and an interval tb3 between the scattering patterns 30 located in the third scattering pattern row and the scattering patterns 30 located in the fourth scattering pattern row.

Therefore, the arrangement density of the scattering patterns 30 may be increased from the light incidence surface 10s1 toward the counter surface 10s3 by adjusting the area and interval of each scattering pattern 30.

The arrangement density of the scattering patterns 30 can be adjusted not just using the area and interval of each scattering pattern 30 as described above. In an exemplary embodiment of the present inventive concept, the arrangement density may also be adjusted by placing a larger number of scattering patterns 30 of the same size from the light incidence surface 10s1 toward the counter surface 10s3.

In addition, it is possible to obtain the same effect as adjusting the arrangement density by adjusting the shape, surface characteristics, material, etc. of each scattering pattern 30, instead of the area and interval of each scattering pattern 30.

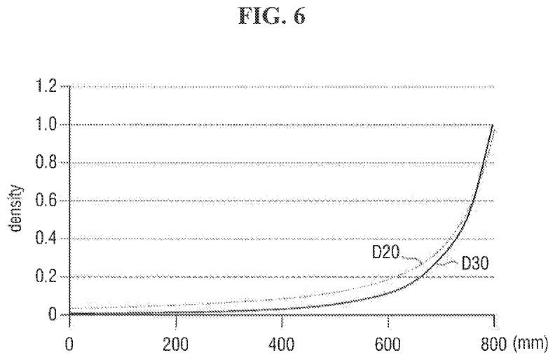

FIG. 6 illustrates relative arrangement densities of the wavelength conversion patterns 20 and the scattering patterns 30 according to a region. As described above, the arrangement density of the wavelength conversion patterns 20 and the scattering patterns 30 may vary according to a region. In the graph of FIG. 6, the X axis represents the distance from the light incidence surface 10s1, and the Y axis represents the relative density of patterns. In the graph of FIG. 6, the light guide plate 10 in which the distance from the light incidence surface 10s1 to the counter surface 10s3 is 800 mm is described as an example. However, the size of the light guide plate 10 is not limited to this example. A region of 0 mm on the X axis will be described below as the light incidence surface 10s1, and a region of 800 mm will be described below as the counter surface 10s3.

Referring further to FIG. 6, the graph includes a first curve D20 and a second curve D30. The first curve D20 represents the relative density of the wavelength conversion patterns 20, and the second curve D30 represents the relative density of the scattering patterns 30. Here, the relative density may refer to the arrangement density of patterns in a region relative to the maximum arrangement density of the patterns on the counter surface side 10s3. The relative densities of the first curve D20 and the second curve D30 are all 1.0 mm on the counter surface side 10s3. However, this refers to just the relative densities of the wavelength conversion patterns 20 and the scattering patterns 30. This does not mean that the arrangement density of the wavelength conversion patterns 20 and the arrangement density of the scattering patterns 30 are the same. For example, the overall arrangement density of the wavelength conversion patterns 20 may be higher than that of the scattering patterns 30.

The first curve D20 shows that the arrangement density of the wavelength conversion patterns 20 increases from the light incidence surface 10s1 toward the counter surface 10s3. Since the amount of light guided by the light guide plate 10 decreases from the light incidence surface 10s1 toward the counter surface 10s3, the arrangement density of the wavelength conversion patterns 20 may be increased to increase the light conversion efficiency on the counter surface side 10s3. Some wavelength conversion patterns 20 may also be disposed on the light incidence surface side 10s1 to convert light incident into the light guide plate 10.

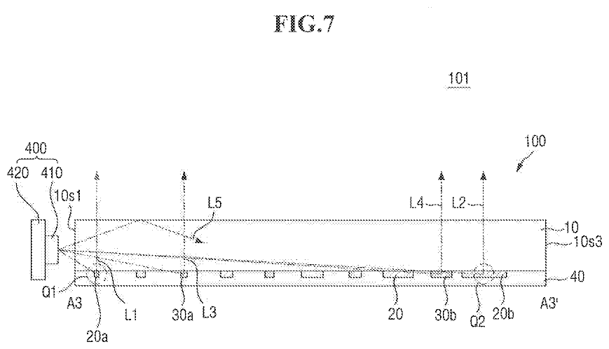

Like the first curve D20, the second curve D30 shows that the arrangement density of the scattering patterns 30 increases from the light incidence surface 10s1 toward the counter surface 10s3. Referring to the second curve D30 for comparison with the first curve D20, it can be seen that the scattering patterns 30 are barely disposed on the light incidence surface side 10s1 and rapidly increase in number toward the counter surface 10s3. The increase in the number of the scattering patterns 30 toward the counter surface 10s3 will be described later with reference to FIGS. 7 through 9.

Referring back to FIGS. 1 through 5, the scattering patterns 30 may be disposed between the wavelength conversion patterns 20 and spaced apart from the wavelength conversion patterns 20. For example, a scattering arrangement column formed by the scattering patterns 30 may be disposed between wavelength conversion pattern columns formed by the wavelength conversion patterns 20. For example, the first scattering pattern column may be disposed between the first wavelength conversion pattern column and the second wavelength conversion pattern column. In addition, a scattering pattern row formed by the scattering patterns 30 may be disposed between wavelength conversion pattern rows formed by the wavelength conversion patterns 20.

Since the wavelength conversion patterns 20 and the scattering patterns 30 are disposed on the lower surface 10b of the light guide plate 10, if they overlap each other, the light conversion efficiency of the wavelength conversion patterns 20 and the light output efficiency of the scattering patterns 30 may be reduced. Therefore, the wavelength conversion patterns 20 and the scattering patterns 30 may be spaced apart from each other in a plan view without overlapping each other. However, the present inventive concept is not limited to this case. In exemplary embodiments of the present inventive concept, when the wavelength conversion patterns 20 and the scattering patterns 30 are disposed on different surfaces, for example, when the wavelength conversion patterns 20 are disposed on the upper surface 10a of the light guide plate 10 and the scattering patterns 30 are disposed on the lower surface 10b of the light guide plate 10, the wavelength conversion patterns 20 and the scattering patterns 30 may partially overlap each other in a plan view.

The passivation layer 40 may be disposed on the lower surface 10b of the light guide plate 10 to cover the wavelength conversion patterns 20 and the scattering patterns 30. The passivation layer 40 prevents the penetration of moisture/oxygen. The passivation layer 40 may include an inorganic material such as silicon nitride, aluminum nitride, zirconium nitride, titanium nitride, hafnium nitride, tantalum nitride, silicon oxide, aluminum oxide, titanium oxide, tin oxide, cerium oxide, silicon oxynitride, or a metal thin film having secured light transmittance. In an exemplary embodiment of the present inventive concept, the passivation layer 40 may be made of silicon nitride.

The passivation layer 40 may completely cover the wavelength conversion patterns 20. In an exemplary embodiment of the present inventive concept, the passivation layer 40 may completely cover the scattering patterns 30 in addition to the wavelength conversion patterns 20. In exemplary embodiments of the present inventive concept, the scattering patterns 30 may not be covered by the passivation layer 40.

The thickness of the passivation layer 40 may be smaller than that of the wavelength conversion patterns 20. The thickness of the passivation layer 40 may be 0.1 μm to 2 μm. If the thickness of the passivation layer 40 is 0.1 μm or more, the passivation layer 40 can exhibit a significant moisture/oxygen penetration preventing function. If the thickness is 0.3 μm or more, the passivation layer 40 can have an effective moisture/oxygen penetration preventing function. The passivation layer 40 having a thickness of 2 μm or less as not as advantageous in terms of thinning and transmittance. In an exemplary embodiment of the present inventive concept, the thickness of the passivation layer 40 may be about 0.4 μm.

The wavelength conversion patterns 20, particularly the wavelength conversion particles included in the wavelength conversion patterns 20, are vulnerable to moisture/oxygen. In the case of a wavelength conversion film, a barrier film is laminated on upper and lower surfaces of a wavelength conversion layer to prevent the penetration of moisture/oxygen into the wavelength conversion layer. In the current embodiment, however, since the wavelength conversion patterns 20 are directly disposed on the light guide plate 10 without a barrier film, a sealing structure for protecting the wavelength conversion patterns 20 is required. The sealing structure may be realized by the passivation layer 40 and the light guide plate 10.

The passivation layer 40 may be thinner than the wavelength conversion patterns 20 and the scattering patterns 30 and may be disposed with a substantially uniform thickness along the surface shape of the lower surface 10b of the light guide plate 10. Although the passivation layer 40 is illustrated as being planar in the drawings for ease of description, it may be disposed with a constant thickness along the surface shape of the lower surface 10b of the light guide plate 10.

The passivation layer 40 may be formed by a method such as vapor deposition. For example, the passivation layer 40 may be formed using chemical vapor deposition on the light guide plate 10 on which the wavelength conversion patterns 20 and the scattering patterns 30 are sequentially formed. However, the method of forming the passivation layer 40 is not limited to the above example, and various other lamination methods can be applied.

As described above, the optical member 100, which is an integrated single member, can simultaneously perform a light guide function and a wavelength conversion function. The integrated single member can simplify the process of assembling a display. In addition, the optical member 100 can prevent deterioration of the wavelength conversion patterns 20 by sealing the wavelength conversion patterns 20 with the passivation layer 40.

FIGS. 7 through 9 schematically illustrate optical characteristics of the wavelength conversion patterns 20 and the scattering patterns 30.

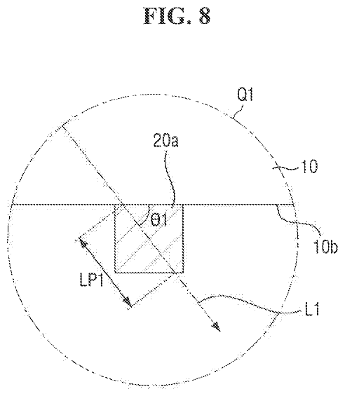

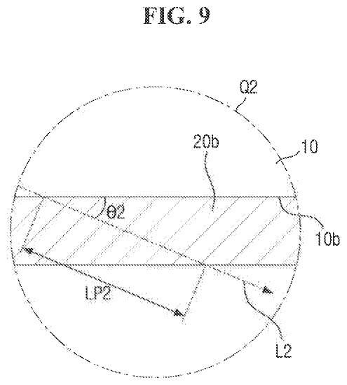

For example, FIG. 7 is a cross-sectional view of the optical member 100 and the light source 400 of FIG. 2 taken along the line A3-A3′ and schematically illustrates a process in which light emitted from the light source 400 enters the light guide plate 10 and travels within the light guide plate 10. FIG. 8 is an enlarged view of a region Q1 of FIG. 7, and FIG. 9 is an enlarged view of a region Q2 of FIG. 7.

Referring to FIG. 7, the light source 400 may be disposed on the light incidence surface side 10s1 of the light guide plate 10 to emit light into the light guide plate 10. The light source 400 may emit light uniformly in all directions, in other words, in a Lambertian manner. Light emitted from the light source 400 may be incident into the light guide plate 10. The light incident into the light guide plate 10 may travel from the light incidence surface 10s1 toward the counter surface 10s3 through internal total reflection. For example, fifth light L5 is light incident on the upper surface 10a of the light guide plate 10 in a region adjacent to the light incidence surface 10s1. Since the upper surface 10a of the light guide plate 10 is in contact with the air layer, a difference in refractive index may be sufficient to cause internal total reflection. In other words, the fifth light L5 may be guided toward the counter surface 10s3 by total reflection within the light guide plate 10.

First light L1 and second light L2 are light traveling toward the lower surface 10b of the light guide plate 10 among the light incident into the light guide plate 10. The first light L1 is incident on a first wavelength conversion pattern 20a disposed closest to the light incidence surface 10s1 among the wavelength conversion patterns 20 disposed on the lower surface 10b of the light guide plate 10. The second light L2 is incident on a second wavelength conversion pattern 20b disposed closest to the counter surface 10s3 among the wavelength conversion patterns 20 disposed on the lower surface 10b of the light guide plate 10.

The first light L1 and the second light L2 may both enter the wavelength conversion patterns 20, and their wavelengths may be converted by the wavelength conversion patterns 20. In other words, the first light L1 and the second light L2 may be blue light emitted from the light source 400 and may be wavelength-converted by the wavelength conversion patterns 20 to further produce green light and red light.

The first light L1 whose wavelength has been converted by the first wavelength conversion pattern 20a and the second light L2 whose wavelength has been converted by the second wavelength conversion pattern 20b may have different colors. For example, an angle at which the first light L1 is incident on the first wavelength conversion pattern 20a adjacent to the light incidence surface 10s1 may be different from an angle at which the second light L2 is incident on the second wavelength conversion pattern 20b adjacent to the counter surface 10s3. This may cause a difference between internal light paths of the first and second wavelength conversion patterns 20a and 20b, resulting in a difference in the magnitudes of red light and green light contained in the first light L1 and the second light L2.

The region Q1 is a region in which the first light L1 is incident on the first wavelength conversion pattern 20a, and the region Q2 is a region in which the second light L2 is incident on the second wavelength conversion pattern 20b. The color difference between the first light L1 and the second light L2 will now be described by additionally referring to FIGS. 8 and 9 which are enlarged views of the regions Q1 and Q2.

Referring to FIGS. 8 and 9, the first light L1 incident on the first wavelength conversion pattern 20a may form a first incidence angle θ1 with the lower surface 10b of the light guide plate 10. The second light L2 incident on the second wavelength conversion pattern 20b may form a second incidence angle θ2 with the lower surface 10b of the light guide plate 10. Since the first wavelength conversion pattern 20a is disposed closer to the light incidence surface 10s1 than the second wavelength conversion pattern 20b, the first incidence angle θ1 of the first light L1 incident on the first wavelength conversion pattern 20a may be larger than the second incidence angle θ2 of the second light L2 incident on the second wavelength conversion pattern 20b.

Since the first incidence angle θ1 is larger than the second incidence angle θ2, a first light path LP1 of the first light L1 moving inside the first wavelength conversion pattern 20a may be longer than a second light path LP2 of the second light L2 moving inside the second wavelength conversion pattern 20b.

In other words, the second light L2 may stay longer within the wavelength conversion pattern 20 than the first light L1. Accordingly, more of the second light L2 may be wavelength-converted by the wavelength conversion particles located inside the second wavelength conversion pattern 20b. Therefore, the second light L2 may include more red light and green light than the first light L1. In other words, the second light L2 may be yellowish as compared with the first light L1.

Consequently, if only the wavelength conversion patterns 20 are disposed on the lower surface 10b of the light guide plate 10, light output from the light incidence surface side 10s1 of the light guide plate 10 and light output from the counter surface side 10s3 of the light guide plate 10 may be different in color. This difference in the color of the output light may be compensated for by the scattering patterns 30.

Referring back to FIG. 7, third light L3 is incident on a first scattering pattern 30a disposed closest to the light incidence surface 10s1 among the scattering patterns 30 disposed on the lower surface 10b of the light guide plate 10, and fourth light L4 is incident on a second scattering pattern 30b disposed closest to the counter surface 10s3 among the scattering patterns 30 disposed on the lower surface 10b of the light guide plate 10.

The third light L3 and the fourth light L4 may be blue light and may respectively be incident on the first scattering pattern 30a and the second scattering pattern 30b to be output toward the upper surface 10a of the light guide plate 10. The output third light L3 and fourth light L4 may be mixed with the first light L1 and the second light L2 described above to improve the color difference between the light incidence surface side 10s1 and the counter surface side 10s3.

The area of the first scattering pattern 30a may be smaller than that of the second scattering pattern 30b. In other words, the arrangement density of the scattering patterns 30 disposed on the counter surface side 10s3 may be higher than the arrangement density of the scattering patterns 30 disposed on the light incidence surface side 10s1.

As described above, the arrangement density of the scattering patterns 30 increases from the light incidence surface 10s1 toward the counter surface 10s3. Even if the same amount of light is incident, more light may be output toward the upper surface 10a of the light guide plate 10 because the arrangement density of the scattering patterns 30 is higher. Since the first scattering pattern 30a is disposed adjacent to the light incidence surface 10s1, more light may be incident on the first scattering pattern 30a than on the second scattering pattern 30b. However, since the second scattering pattern 30b is larger in area and higher in arrangement density than the first scattering pattern 30a, more blue light may be output from the second scattering pattern 30b.

As described above, light output from the wavelength conversion patterns 20 may become yellowish from the light incidence surface 10s1 toward the counter surface 10s3. Accordingly, the arrangement density of the scattering patterns 30 may become higher from the light incidence surface 10s1 toward the counter surface 10s3, and the magnitude of blue light output from the scattering patterns 30 may become greater toward the counter surface 10s3. Consequently, light with an improved color difference may be uniformly output toward the upper surface 10a of the light guide plate 10.

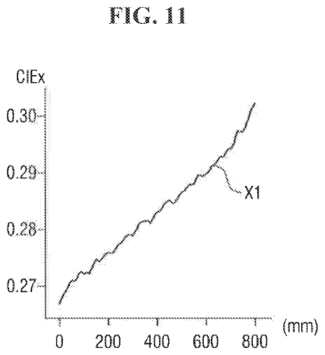

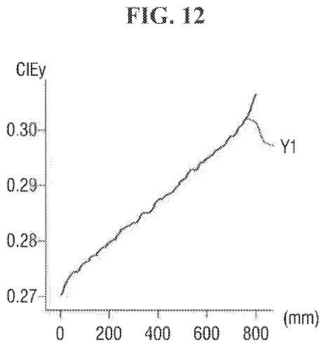

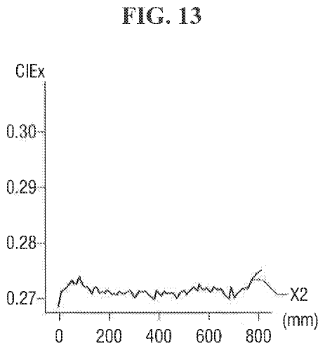

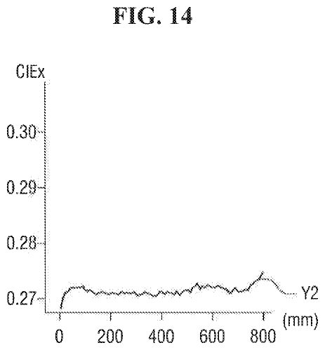

To confirm the color difference improving effect of the scattering patterns 30, the light guide plate 10 including the scattering patterns 30 and, as a comparative example, a light guide plate including only the wavelength conversion patterns 20 without including the scattering patterns 30 were prepared. FIGS. 11 through 14 are graphs for explaining the effect of improving the color difference between a light incidence portion and a counter portion in a light guide plate structured not to include scattering patterns and a light guide plate structured to include the scattering patterns. For example, FIGS. 11 and 12 are graphs illustrating color coordinates of a structure not including scattering patterns, and FIGS. 13 and 14 are graphs illustrating color coordinates of a structure including the scattering patterns. The color coordinates refer to color coordinates according to the CIE 1931 coordinate system. The color coordinates include an x value and a y value, and a color may be determined by the x value and the y value.

First, referring to FIGS. 11 and 12, the X axis of FIGS. 11 and 12 represents the distance from the light incidence surface 10s1 of the light guide plate 10 to the counter surface 10s3. Here, 0 mm indicates the light incidence surface 10s1, and 800 mm indicates the counter surface 10s3. The Y axis of FIG. 11 represents the x value X1 of the color coordinates of the light guide plate not including the scattering patterns according to the distance from the light incidence surface 10s1. The Y axis of FIG. 12 represents the y value Y1 of the color coordinates of the light guide plate not including the scattering patterns according to the distance from the light incidence surface 10s1.

It can be seen that both the x value X1 and the y value Y1 of the light guide plate not including the scattering patterns increase toward the counter surface 10s3. When the x value X1 and the y value Y1 increase toward the counter surface 10s3, the proportion of blue light is reduced and the color gradually changes to become yellowish. In other words, in the graphs of FIGS. 11 and 12, the difference in the x value X1 and the y value Y1 between the light incidence surface 10s1 and the counter surface 10s3 indicates the color difference between the light incidence surface 10s1 and the counter surface 10s3.

On the other hand, referring to FIGS. 13 and 14, it can be seen that an x value X2 and a y value Y2 of the light guide plate including the scattering patterns are, on the whole, constant. In other words, the difference in the x value X2 and the y value Y2 between the light incidence surface 10s1 and the counter surface 10s3 is not great as compared with the light guide plate not including the scattering patterns, which means that the color difference has been improved.

Hereinafter, optical members according to other exemplary embodiments of the present inventive concept will be described. In the following embodiments, elements identical to those of the above-described embodiment may be indicated by the same reference numerals, and a description of those elements will be omitted or given briefly. The following embodiments will be described, focusing mainly on differences from the above-described embodiment. Cutting lines in the drawings described below are located at the same positions as the cutting lines of FIG. 2 in a plan view.

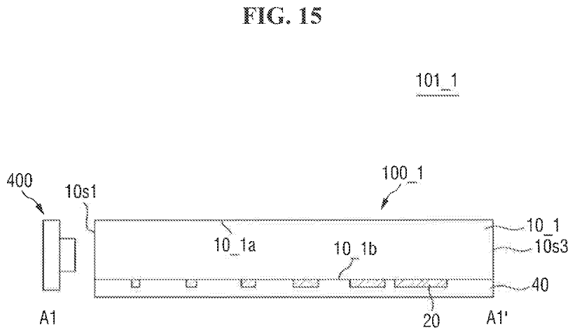

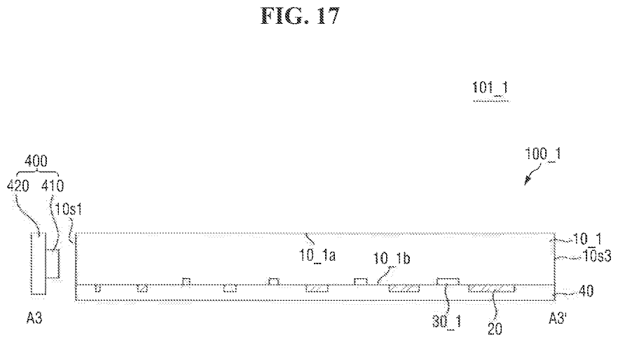

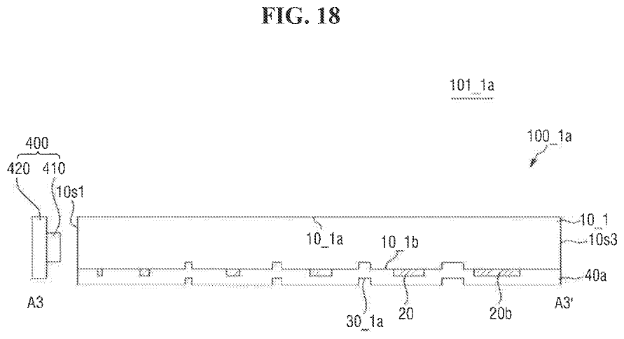

FIGS. 15 through 17 are cross-sectional views of a backlight unit 101_1 according to an exemplary embodiment of the present inventive concept. FIG. 18 is a modified example of the structure illustrated in FIG. 17. The embodiment of FIGS. 15 through 18 is different from the embodiment of FIGS. 1 through 5 in that scattering patterns 30_1 are formed as concave groove patterns on a lower surface 10_1b of a light guide plate 10_1. Hereinafter, differences from the embodiment of FIGS. 1 through 5 will be mainly described.

Referring to FIGS. 15 through 17, the backlight unit 101_1 includes an optical member 100_1 and a light source 400. The optical member 100_1 includes the light guide plate 10_1, wavelength conversion patterns 20, the scattering patterns 30_1, and a passivation layer 40 covering the wavelength conversion patterns 20.

The scattering patterns 30_1 may be formed as concave groove patterns on the lower surface 10_1b of the light guide plate 10_1. For example, the scattering patterns 30_1 may be formed of the surface shape of the lower surface 10_1b of the light guide plate 10_1. After the scattering patterns 30_1 are formed as concave grooves on the lower surface 10_1b of the light guide plate 10_1, the wavelength conversion patterns 20 may be formed not to overlap the scattering patterns 30_1 as shown in FIG. 17. Like the scattering patterns 30 of the above-described embodiment, the scattering patterns 30_1 may change the angle of light traveling inside the light guide plate 10_1 and then emit the light to an area above the light guide plate 10_1.

The area of each concave groove formed by the scattering patterns 30_1 may increase from a light incidence surface 10s1 toward a counter surface 10s3, and the interval between the concave grooves may decrease from the light incidence surface 10s1 toward the counter surface 10s3. In other words, the arrangement density of the scattering patterns 30_1 in the form of concave grooves may gradually increase. Alternatively, the area of each concave groove may be the same, but the number of concave groove patterns may gradually increase.

After the scattering patterns 30_1 and the wavelength conversion patterns 20 are formed, the passivation layer 40 may be disposed on the lower surface 10_1b of the light guide plate 10_1. The passivation layer 40 may cover the scattering patterns 30_1 formed on the lower surface 10_1b of the light guide plate 10_1. Since the scattering patterns 30_1 are concave groove patterns, an air layer may be formed between the passivation layer 40 and the light guide plate 10_1 at positions where the scattering patterns 30_1 are formed. However, the present inventive concept is not limited to this case, and the passivation layer 40 may also be formed to a uniform thickness along the surface of the lower surface 10_1b of the light guide plate 10_1. For example, in a backlight unit 101_1a of FIG. 18, a passivation layer 40a is formed to have a uniform thickness along the surface shape of a lower surface 10_b of a light guide plate 10_1 having scattering patterns 30_1, as described above. For example, the passivation layer 40a may be concave in areas where the scattering patterns 30_1 are located.

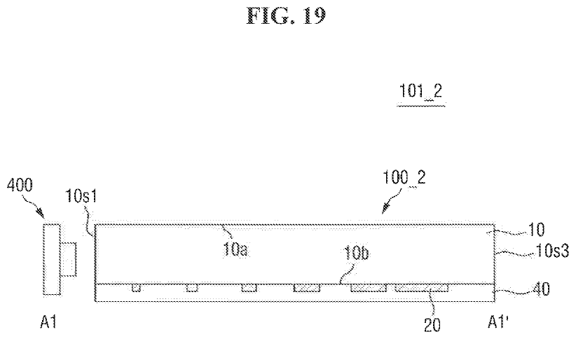

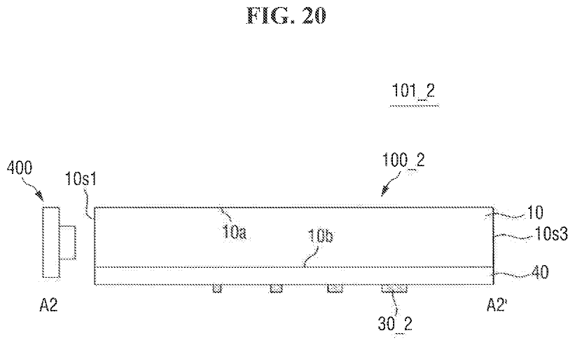

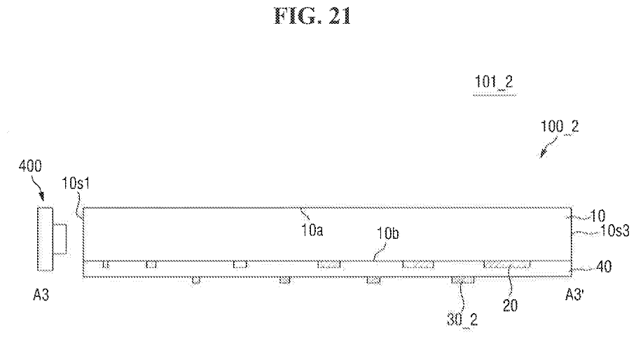

FIGS. 19 through 21 are cross-sectional views of a backlight unit 101_2 according to an exemplary embodiment of the present inventive concept. The embodiment of FIGS. 19 through 21 is different from the embodiment of FIGS. 1 through 5 in that scattering patterns 30_2 are disposed not on a lower surface 10b of a light guide plate 10, but on a lower surface of a passivation layer 40. Hereinafter, differences from the above-described embodiment will be mainly described.

Referring to FIGS. 19 through 21, the backlight unit 101_2 includes an optical member 100_2 and a light source 400. The optical member 100_2 includes the light guide plate 10, wavelength conversion patterns 20, the scattering patterns 30_2, and the passivation layer 40.

The scattering patterns 30_2 may be disposed on the lower surface of the passivation layer 40. In other words, the wavelength conversion patterns 20 may be disposed on the lower surface 10b of the light guide plate 10, and the passivation layer 40 may be disposed to cover the wavelength conversion patterns 20. Then, the scattering patterns 30_2 may be disposed on the lower surface of the passivation layer 40. For example, the passivation layer 40 may be disposed between the wavelength conversion patterns 20 and the scattering patterns 30_2.

The shape and arrangement of the scattering patterns 30_2 may be the same as those of the scattering patterns 30 in the embodiment of FIGS. 1 through 5. In other words, the scattering patterns 30_2 may not to overlap the wavelength conversion patterns 20 in a plan view, and the arrangement density of the scattering patterns 30_2 may increase from a light incidence surface 10s 1 toward a counter surface 10s3. However, the shape and arrangement of the scattering patterns 30_2 are not limited to this example.

It is to be understood that the scattering patterns 30_2 may partially overlap the wavelength conversion patterns 20 in some embodiments of the present inventive concept. In other words, since the scattering patterns 30_2 and the wavelength conversion patterns 20 are disposed on different layers, they may overlap each other. For example, the area of each scattering pattern 30_2 may be larger than that of each scattering pattern 30 of the embodiment of FIGS. 1 through 5. When the area of each scattering pattern 30_2 is large, the scattering patterns 30_2 may at least partially overlap the wavelength conversion patterns 20, but may output more light. When blue light for improving the color difference is insufficient, the scattering patterns 30_2 may be placed on a different layer from the wavelength conversion patterns 20, and the area of each scattering pattern 30_2 may be increased, so that a sufficient amount of blue light for improving the color difference can be output.

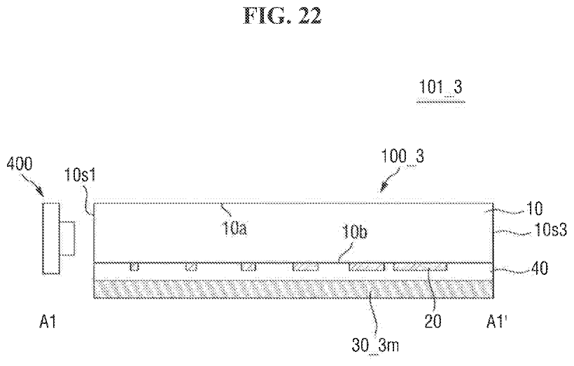

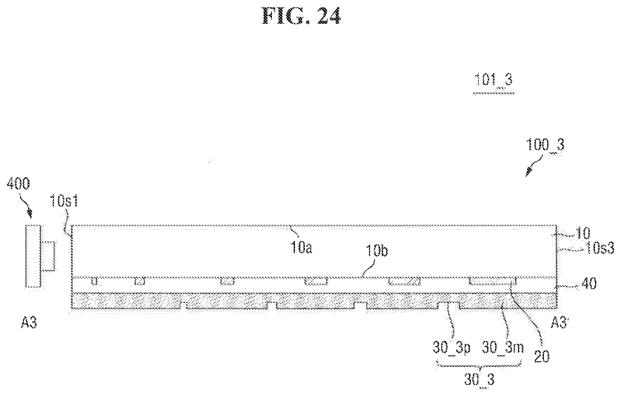

FIGS. 22 through 24 are cross-sectional views of a backlight unit 101_3 according to an exemplary embodiment of the present inventive concept. The embodiment of FIGS. 22 through 24 is different from the embodiment of FIGS. 19 through 21 in that scattering patterns 30_3 are formed as a separate pattern layer on a lower surface of a passivation layer 40. Hereinafter, differences from the above-described embodiment will be mainly described.

Referring to FIGS. 22 through 24, the backlight unit 101_3 includes an optical member 100_3 and a light source 400. The optical member 100_3 may include a light guide plate 10, wavelength conversion patterns 20, the scattering patterns 30_3, and the passivation layer 40.

The scattering patterns 30_3 may be provided as a separate pattern layer. For example, the scattering patterns 30_3 may include a resin layer 30_3m and pattern portions 30_3p formed on a lower surface of the resin layer 30_3m. When the scattering patterns 30_3 are formed by an imprinting method, they may be formed using the resin layer 30_3m having a refractive index equal to or greater than that of the light guide plate 10. In other words, after the resin layer 30_3m is formed on the lower surface of the passivation layer 40, the pattern portions 30_3p may be formed on the lower surface of the resin layer 30_3m using a stamper. However, this method of forming the scattering patterns 30_3 as a separate pattern layer is merely an example, and the present inventive concept is not limited to this example.

The shape and arrangement of the scattering patterns 30_3 may be the same as or similar to those of the scattering patterns 30_2 described with reference to FIGS. 19 through 21 except that the scattering patterns 30_3 are provided as a separate pattern layer, and thus a detailed description thereof is omitted. In exemplary embodiments of the present inventive concept, the pattern portions 30_3p of the scattering patterns 30_3 may at least partially overlap the wavelength conversion patterns 20 in a plan view. For example, a wide pattern portion 30_3p may overlap with a wide wavelength conversion pattern 20.

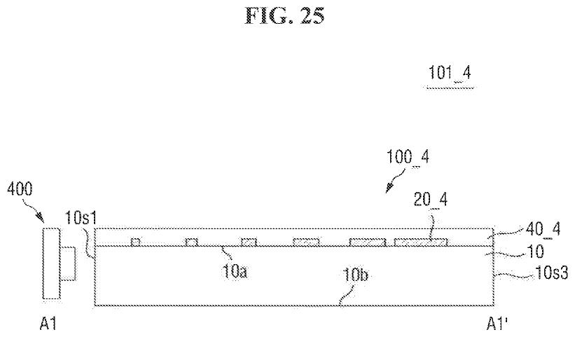

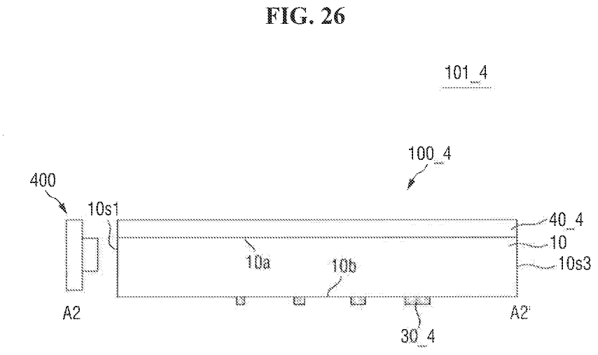

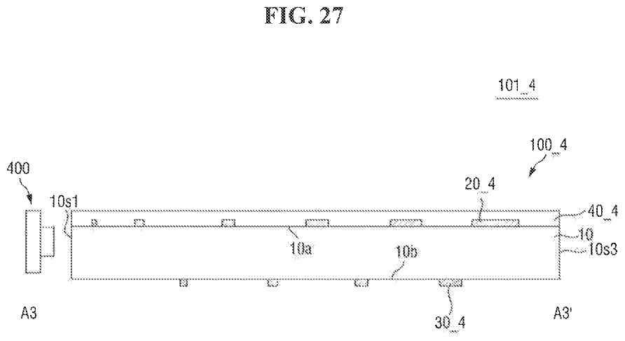

FIGS. 25 through 27 are cross-sectional views of a backlight unit 101_4 according to an exemplary embodiment of the present inventive concept. The embodiment of FIGS. 25 through 27 is different from the embodiment of FIGS. 1 through 5 in that wavelength conversion patterns 20_4 and a passivation layer 40_4 are disposed on an upper surface 10a of a light guide plate 10, whereas scattering patterns 30_4 are disposed on a lower surface 10b of the light guide plate 10. Hereinafter, differences from the above-described embodiment will be mainly described.

Referring to FIGS. 25 through 27, the backlight unit 101_4 includes an optical member 100_4 and a light source 400. The optical member 100_4 may include the light guide plate 10, the wavelength conversion patterns 20_4, the scattering patterns 30_4, and the passivation layer 40_4.

The wavelength conversion patterns 20_4 may be disposed on the upper surface 10a of the light guide plate 10. The arrangement of the wavelength conversion patterns 20_4 in a plan view may be the same as that of the wavelength conversion patterns 20 of the embodiment of FIGS. 1 through 5. In other words, the arrangement density of the wavelength conversion patterns 20_4 may increase from a light incidence surface 10s1 toward a counter surface 10s3. However, the present inventive concept is not limited to this case. For example, the area of each wavelength conversion pattern 20_4 may be increased depending on its ability to enhance the wavelength conversion efficiency.

The scattering patterns 30_4 may be disposed on the lower surface 10b of the light guide plate 10. The specific shape and arrangement of the scattering patterns 30_4 may be the same as or similar to those of the scattering patterns 30 of the above-described embodiment. In other words, the scattering patterns 30_4 may be disposed not to overlap the wavelength conversion patterns 20_4 in a plan view. However, the present inventive concept is not limited to this case. In some exemplary embodiments of the present inventive concept, the scattering patterns 30_4 may overlap the wavelength conversion patterns 20_4 in a plan view. Even when the scattering patterns 30_4 and the wavelength conversion patterns 20_4 overlap each other in a plan view, light output from the scattering patterns 30_4 may be induced to proceed to the outside without entering the wavelength conversion patterns 20_4 by adjusting the shape and surface characteristics of the scattering patterns 30_4.

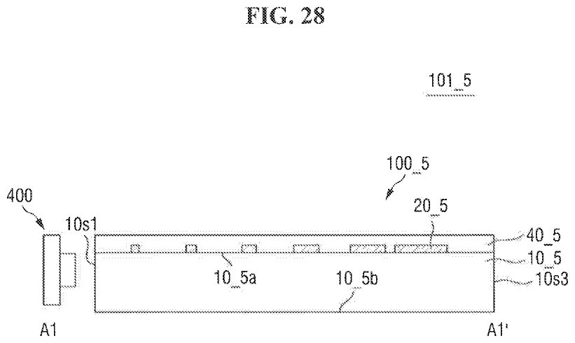

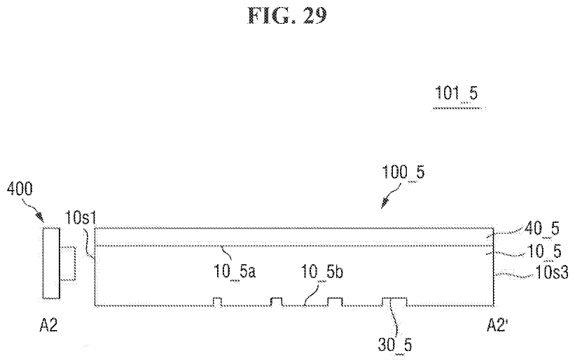

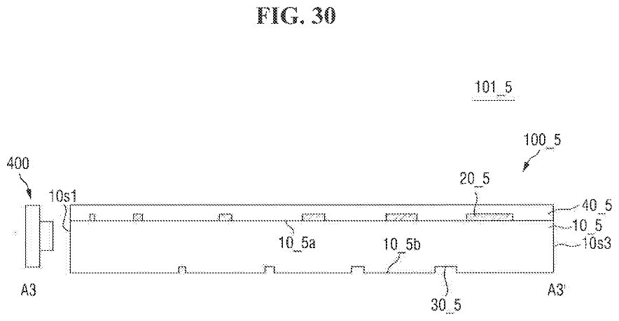

FIGS. 28 through 30 are cross-sectional views of a backlight unit 101_5 according to an exemplary embodiment of the present inventive concept. The embodiment of FIGS. 28 through 30 is different from the embodiment of FIGS. 25 through 27 in that scattering patterns 30_5 are formed as concave groove patterns on a lower surface 10_5b of a light guide plate 10_5. Hereinafter, differences from the above-described embodiment will be mainly described.

Referring to FIGS. 28 through 30, the backlight unit 101_5 includes an optical member 100_5 and a light source 400. The optical member 100_5 may include the light guide plate 10_5, wavelength conversion patterns 20_5, the scattering patterns 30_5, and a passivation layer 40_5.

The wavelength conversion patterns 20_5 may be disposed on an upper surface 10_5a of the light guide plate 10_5 as in the embodiment of FIGS. 25 through 27, and the passivation layer 40_5 may be disposed on the upper surface 10_5a of the light guide plate 10_5 to cover the wavelength conversion patterns 20_5. The wavelength conversion patterns 20_5 may be disposed between the passivation layer 40_5 and the scattering patterns 30_5.

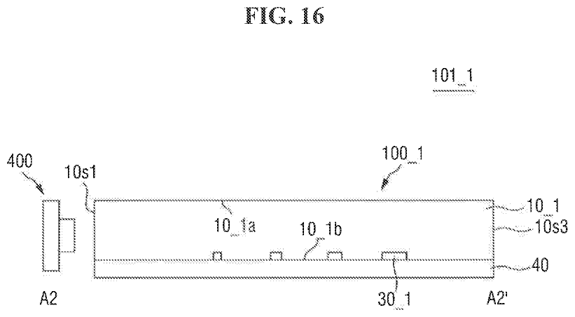

The scattering patterns 30_5 may be formed as concave groove patterns on the lower surface 10_5b of the light guide plate 10_5 as in the embodiment of FIGS. 15 through 17. The shape and arrangement of the scattering patterns 30_5 may be the same as or similar to those of the scattering patterns 30_1 (see FIG. 16) of the above-described embodiment, and thus, a detailed description thereof is omitted. In some embodiments of the present inventive concept, the scattering patterns 30_5 may at least partially overlap the wavelength conversion patterns 20_5.

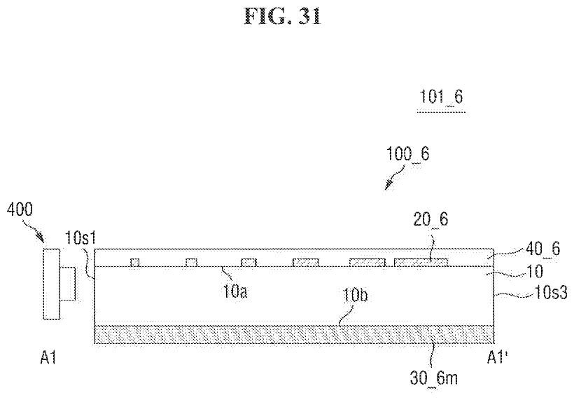

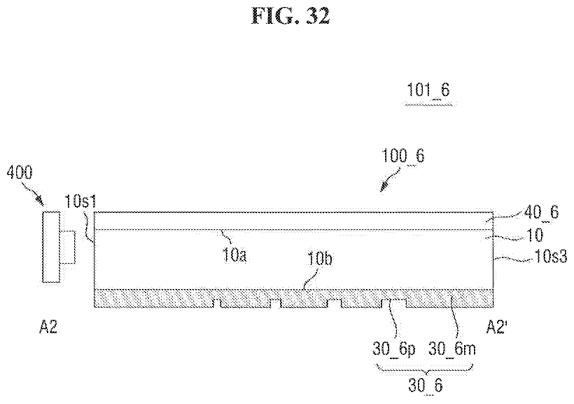

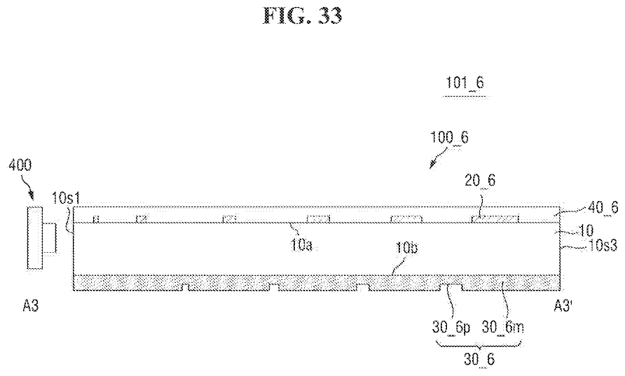

FIGS. 31 through 33 are cross-sectional views of a backlight unit 101_6 according to an exemplary embodiment of the present inventive concept. The embodiment of FIGS. 31 through 33 is different from the embodiment of FIGS. 25 through 27 in that scattering patterns 30_6 are formed as a separate pattern layer on a lower surface 10b of a light guide plate 10. Hereinafter, differences from the above-described embodiment will be mainly described.

Referring to FIGS. 31 through 33, the backlight unit 101_6 includes an optical member 100_6 and a light source 400. The optical member 100_6 may include the light guide plate 10, wavelength conversion patterns 20_6, the scattering patterns 30_6, and a passivation layer 40_6.

The wavelength conversion patterns 20_6 may be disposed on an upper surface 10a of the light guide plate 10 as in the embodiment of FIGS. 25 through 27, and the passivation layer 40_6 may be disposed on the upper surface 10a of the light guide plate 10 to cover the wavelength conversion patterns 20_6.

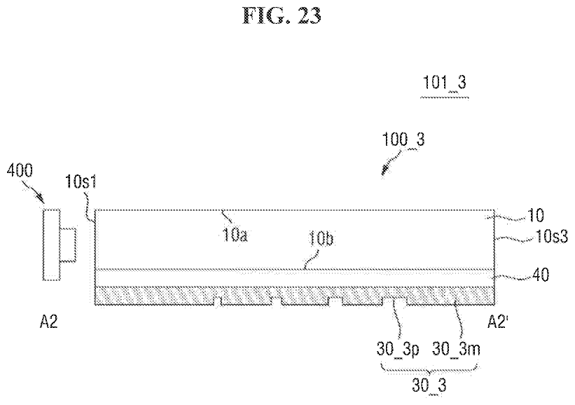

The scattering patterns 30_6 may be provided as a separate pattern layer as in the embodiment of FIGS. 22 through 24. The scattering patterns 30_6 may include a resin layer 30_6m and pattern portions 30_6p formed on a lower surface of the resin layer 30_6m. The pattern portions 30_6p may be formed on the resin layer 30_6m by, but not limited to, an imprinting method. The shape and arrangement of the scattering patterns 30_6 may be the same as or similar to those of the scattering patterns 30_3 (see FIG. 23) of the above-described embodiment, and thus a detailed description thereof is omitted. In some exemplary embodiments of the present inventive concept, the pattern portions 30_6p of the scattering patterns 30_6 may at least partially overlap the wavelength conversion patterns 20_6 in plan view.

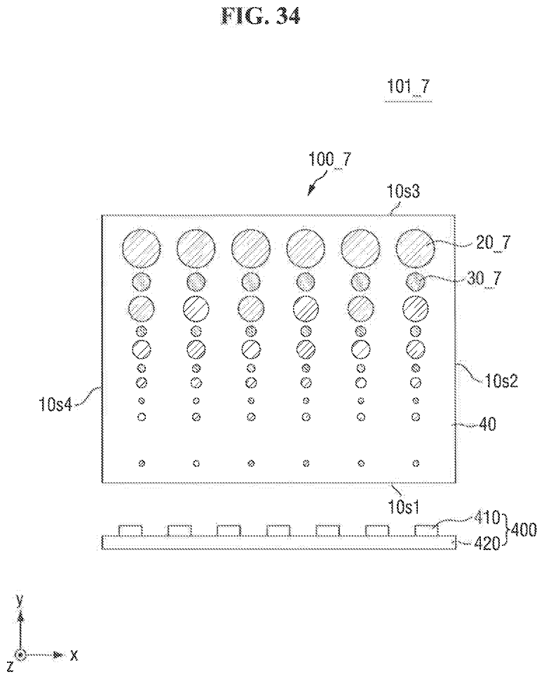

FIGS. 34, 35, 36 and 37 are plan views of backlight units 101_7, 101_8, 101_9 and 101_10 according to exemplary embodiments of the present inventive concept. The embodiments of FIGS. 34 through 37 are different from the embodiment of FIGS. 1 through 5 in the arrangement relationship between wavelength conversion patterns 20_7, 20_8, 20_9 and 20_10 and scattering patterns 30_7, 30_8, 30_9 and 30_10. Hereinafter, differences from the above-described embodiment will be mainly described.

Referring to FIG. 34, the backlight unit 101_7 includes an optical member 100_7 and a light source 400. The optical member 100_7 may include the scattering patterns 30_7 disposed on the same lines as columns formed by the wavelength conversion patterns 20_7 in a plan view. Specifically, the wavelength conversion patterns 20_7 are arranged in rows and columns, for example, in a structure of six rows and six columns in FIG. 34. The scattering patterns 30_7 are also arranged in rows and columns, for example, in a structure of four rows and six columns in FIG. 34.

Unlike in the embodiment of FIGS. 1 through 5, scattering pattern columns formed by the scattering patterns 30_7 may not be disposed between wavelength conversion pattern columns formed by the wavelength conversion patterns 20_7 but may be disposed in the same columns as the wavelength conversion pattern columns. In other words, the scattering pattern columns may be disposed on the same lines as the wavelength conversion pattern columns. In the planar structure according to the current embodiment, the wavelength conversion patterns 20_7 and the scattering patterns 30_7 do not overlap each other in a plan view. The planar structure of FIG. 34 is applicable to all of the optical members 100_1 through 100_6 according to the above-described embodiments.

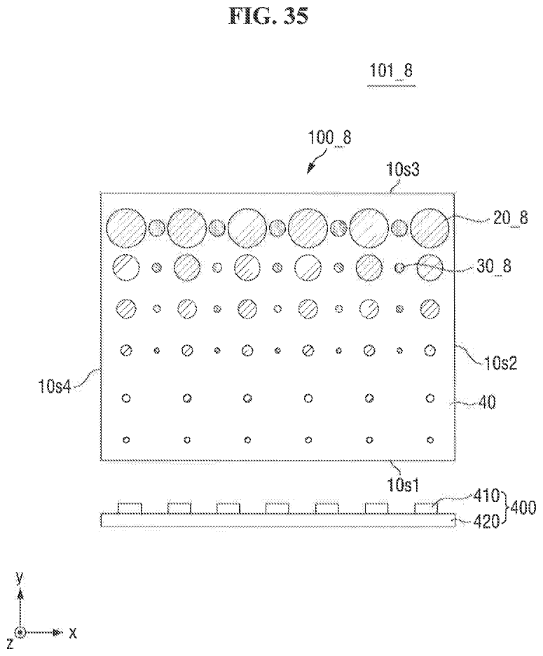

Referring to FIG. 35, the backlight unit 101_8 includes an optical member 100_8 and a light source 400. The optical member 100_8 may include the scattering patterns 30_8 disposed on the same lines as rows formed by the wavelength conversion patterns 20_8 in a plan view. Specifically, the wavelength conversion patterns 20_8 are arranged in rows and columns, for example, in a structure of six rows and six columns in FIG. 35. The scattering patterns 30_8 are also arranged in rows and columns, for example, in a structure of 4 rows and 5 columns in FIG. 35.

Unlike in the above-described embodiment, scattering pattern rows formed by the scattering patterns 30_8 may not be disposed between wavelength conversion pattern rows formed by the wavelength conversion patterns 20_8 but may be disposed in the same rows as the wavelength conversion pattern rows. In other words, the scattering pattern rows may be disposed on the same lines as the wavelength conversion pattern rows, respectively. In the planar structure according to the current embodiment, the wavelength conversion patterns 20_8 and the scattering patterns 30_8 do not overlap each other in a plan view. The planar structure of FIG. 35 is applicable to all of the optical members 100_1 through 100_6 according to the above-described embodiments.

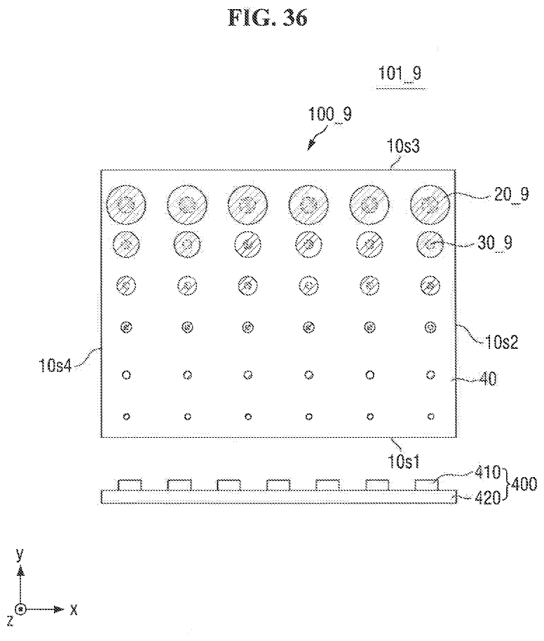

Referring to FIG. 36, the backlight unit 101_9 includes an optical member 100_9 and a light source 400. The optical member 100_9 may include the scattering patterns 30_9 overlapping the wavelength conversion patterns 20_8 in a plan view. As described above, when the wavelength conversion patterns 20_9 and the scattering patterns 30_9 are disposed on the same layer as in the embodiment of FIGS. 1 through 5, they do not overlap each other in a plan view. However, when the wavelength conversion patterns 20_9 and the scattering patterns 30_9 are disposed on different layers, they may at least partially overlap each other. In some cases, the wavelength conversion patterns 20_9 and the scattering patterns 30_9 may completely overlap each other. For example, as shown in FIG. 36, the wavelength conversion patterns 20_9 may completely cover the scattering patterns 30_9.

Since the wavelength conversion patterns 20_9 and the scattering patterns 30_9 overlap each other in a plan view, the planar structure according to the current embodiment may not be applicable to the optical members 100 and 100_1 according to the embodiments in which the wavelength conversion patterns 20_9 and the scattering patterns 30_9 are disposed on the same layer. However, the planar structure according to the current embodiment is applicable to the optical members 100_2 through 100_6 in which the wavelength conversion patterns 20_9 and the scattering patterns 30_9 are disposed on different layers.

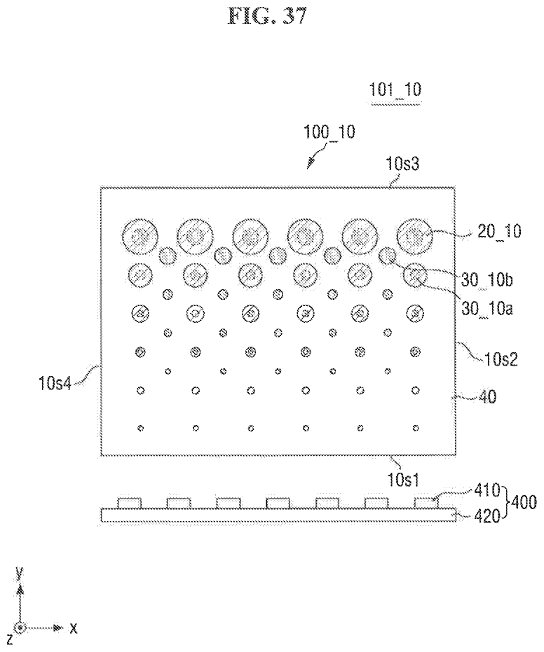

Referring to FIG. 37, the backlight unit 101_10 includes an optical member 100_10 and a light source 400. The optical member 100_10 may include third scattering patterns 30_10a overlapping the wavelength conversion patterns 20_10 in a plan view and fourth scattering patterns 30_10b not overlapping the wavelength conversion patterns 20_10 in a plan view. When the third scattering patterns 30_10a are disposed on a different layer from the wavelength conversion patterns 20_10, they may at least partially overlap the wavelength conversion patterns 20_10 as in the embodiment of FIG. 36. In some exemplary embodiments of the present inventive concept, the wavelength conversion patterns 20_10 and the third scattering patterns 30_10a may completely overlap each other.

In addition, the fourth scattering patterns 30_10b may not overlap the wavelength conversion patterns 20_10 in a plan view as in the embodiment of FIGS. 1 through 5. Since the fourth scattering patterns 30_10b do not overlap the wavelength conversion patterns 20_10, they may be disposed on the same layer as the wavelength conversion patterns 20_10.

The third scattering patterns 30_10a and the fourth scattering patterns 30_10b may be formed together on the same layer. However, the present inventive concept is not limited to this case. For example, the third scattering patterns 30_10a may be disposed on a different layer from the wavelength conversion patterns 20_10, and the fourth scattering patterns 30_10b may be disposed on the same layer as the wavelength conversion patterns 20_10. Thus, the third scattering patterns 30_10a and the fourth scattering patterns 30_10b may be disposed on different layers.

When blue light outputting patterns for improving the color difference between a light incidence surface 10s 1 and a counter surface 10s3 are insufficient, the optical member 100_10 may include both the third scattering patterns 30_10a overlapping the wavelength conversion patterns 20_10 in a plan view and the fourth scattering patterns 30_10b not overlapping the wavelength conversion patterns 20_10 in a plan view to output sufficient blue light for improving the color difference between the light incidence surface 10s1 and the counter surface 10s3.

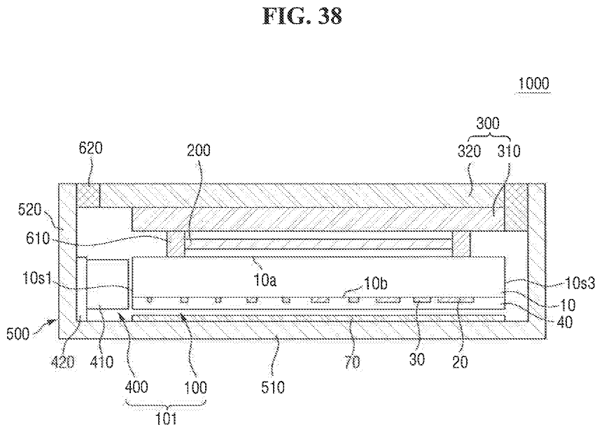

FIG. 38 is a cross-sectional view of a display 1000 according to an exemplary embodiment of the present inventive concept. The display 1000 of FIG. 38 may include the backlight unit 101 described above with reference to FIGS. 1 through 5. For ease of description, a cross-sectional view of the backlight unit 101 disposed in the display 1000 will be described as the cross-sectional view of FIG. 5 obtained by cutting the backlight unit 101 of FIG. 2 along the line A3-A3′ in a plan view. However, the backlight unit 101 disposed in the display 1000 is just an example, and all of the backlight units 101_1 through 101_10 according to the above-described embodiments are applicable to the current embodiment.

Referring to FIG. 38, the display 1000 includes the backlight unit 101 and a display panel 300 disposed above the backlight unit 101. The backlight unit 101 includes an optical member 100 and a light source 400.

The light source 400 is disposed on a side of the optical member 100. The light source 400 may be disposed adjacent to a light incidence surface 10s1 of a light guide plate 10 of the optical member 100. The light source 400 may include a plurality of point light sources or linear light sources. The point light sources may be light emitting diode (LED) light sources 410. The LED light sources 410 may be mounted on a printed circuit board 420. The LED light sources 410 may emit blue light.

In an exemplary embodiment of the present inventive concept, the LED light sources 410 may be top-emitting LEDs that emit light through their top surfaces as illustrated in FIG. 38. In this case, the printed circuit board 420 may be disposed on a bottom surface 510 and a sidewall 520 of a housing 500. It is to be understood, however, that the LED light sources 410 may be side-emitting LEDs that emit light through their side surfaces. In this case, the printed circuit board 420 may be disposed on the bottom surface 510 of the housing 500.

Blue light emitted from the LED light sources 410 is incident on the light guide plate 10 of the optical member 100. The light guide plate 10 of the optical member 100 guides the light and outputs the light through an upper surface 10a or a lower surface 10b of the light guide plate 10. Wavelength conversion patterns 20 of the optical member 100 convert part of the light of the blue wavelength incident from the light guide plate 10 into other wavelengths such as a green wavelength and a red wavelength. The light of the green wavelength and the light of the red wavelength are emitted upward together with the unconverted light of the blue wavelength and provided to the display panel 300.

The display 1000 may further include a reflective member 70 disposed under the optical member 100. The reflective member 70 may include a reflective film or a reflective coating layer. The reflective member 70 reflects light output from the lower surface 10b of the light guide plate 10 of the optical member 100 back into the light guide plate 10.

The display panel 300 is disposed above the backlight unit 101. The display panel 300 receives light from the backlight unit 101 and displays a screen image. Examples of such a light-receiving display panel that receives light and displays a screen image include a liquid crystal display panel and an electrophoretic panel. The liquid crystal display panel will hereinafter be described as an example of the display panel 300, but various other light-receiving display panels can be used.

The display panel 300 may include a first substrate 310, a second substrate 320 facing the first substrate 310, and a liquid crystal layer disposed between the first substrate 310 and the second substrate 320. The first substrate 310 and the second substrate 320 overlap each other. In an exemplary embodiment of the present inventive concept, any one of the first and second substrates 310 and 320 may be larger than the other substrate to protrude further outward than the other substrate. In FIG. 38, the second substrate 320 disposed on the first substrate 310 is larger and protrudes on a side where the light source 400 is disposed. For example, the second substrate 320 partially overlaps the light source 400. The protruding region of the second substrate 320 may provide a space in which a driving chip or an external circuit board is mounted. It is to be understood, however, that the first substrate 310 disposed under the second substrate 320 may also be larger than the second substrate 320 to protrude outward.

The optical member 100 may be coupled to the display panel 300 by an inter-module coupling member 610. The inter-module coupling member 610 may be shaped like a quadrilateral frame in a plan view. The inter-module coupling member 610 may be located at edge portions of the display panel 300 and the optical member 100.

In an exemplary embodiment of the present inventive concept, a lower surface of the inter-module coupling member 610 is disposed on an upper surface of a passivation layer 40 of the optical member 100. The lower surface of the inter-module coupling member 610 may be disposed on the passivation layer 40 to overlap only upper surfaces of the wavelength conversion patterns 20 and not overlap side surfaces of the wavelength conversion patterns 20.

The inter-module coupling member 610 may include a polymer resin or an adhesive or sticky tape.

In some exemplary embodiments of the present inventive concept, the inter-module coupling member 610 may perform the function of a light transmission blocking pattern. For example, the inter-module coupling member 610 may include a light absorbing material such as a black pigment or a dye or may include a reflective material to perform the light transmission blocking function.

The display 1000 may further include the housing 500. The housing 500 has an open surface and includes the bottom surface 510 and sidewalk 520 connected to the bottom surface 510. The light source 400, the optical member 100 and the display panel 300 attached to each other, and the reflective member 70 may be accommodated in a space defined by the bottom surface 510 and the sidewalls 520 of the housing 500. The light source 400, the reflective member 70, and the optical member 100 are disposed on the bottom surface 510 of the housing 500. The height of the sidewalls 520 of the housing 500 may be substantially the same as the total height of the optical member 100 and the display panel 300 attached to each other inside the housing 500. The display panel 300 may be disposed adjacent to an upper end of each sidewall 520 of the housing 500 and may be coupled to the upper end of each sidewall 520 of the housing 500 by a housing coupling member 620. The housing coupling member 620 may be shaped like a quadrilateral frame in a plan view. The housing coupling member 620 may include a polymer resin or an adhesive or sticky tape.

The display 1000 may further include at least one optical film 200. One optical film 200 or a plurality of optical films 200 may be accommodated in a space surrounded by the inter-module coupling member 610 between the optical member 100 and the display panel 300. Side surfaces of the optical film or films 200 may be in contact with and attached to inner side surfaces of the inter-module coupling members 610. Although there is a gap between the optical film or films 200 and the optical member 100 and between the optical film or films 200 and the display panel 300 in FIG. 38, the gap may be omitted.

The optical film or films 200 may be a prism film, a diffusion film, a micro-lens film, a lenticular film, a polarizing film, a reflective polarizing film, a retardation film, etc. The display 1000 may include a plurality of optical films 200 of the same type or different types. When a plurality of optical films 200 are employed, they may be configured to overlap each other, and side surfaces of the optical films 200 may be attached to and in contact with the inner side surfaces of the inter-module coupling member 610. The optical films 200 may be separated from each other, and an air layer may be disposed between the optical films 200.

In a backlight unit according to an exemplary embodiment of the present inventive concept, an optical member can prevent a light leakage defect of a light incidence portion by applying wavelength conversion patterns while improving the color difference between the light incidence portion and a counter portion through scattering patterns.

While the present inventive concept has been particularly shown and described with reference to exemplary embodiments thereof, it will be understood by those of ordinary skill in the art that various changes in form and details may be made therein without departing from the spirit and scope of the present inventive concept as defined by the following claims.

What is claimed is:

1. A backlight unit, comprising:
a light guide plate;
a wavelength conversion pattern disposed on a lower surface of the light guide plate; and
a scattering pattern disposed on the lower surface of the light guide plate,
wherein the wavelength conversion pattern and the scattering pattern do not overlap each other in a plan view.

2. The backlight unit of claim 1, wherein the light guide plate comprises a light incidence surface and a counter surface opposite the light incidence surface, and the backlight unit further comprises a light source facing the light incidence surface, wherein the light source emits blue light.

3. The backlight unit of claim 2, wherein the wavelength conversion pattern comprises a plurality of wavelength conversion patterns spaced apart from each other, wherein the wavelength conversion patterns are arranged along a first direction to form a plurality of wavelength conversion pattern columns, and the first direction is a direction from the light incidence surface toward the counter surface.

4. The backlight unit of claim 3, wherein an arrangement density of the wavelength conversion patterns in the wavelength conversion pattern columns increases from the light incidence surface toward the counter surface.

5. The backlight unit of claim 4, wherein an area of each wavelength conversion pattern in at least one of the wavelength conversion pattern columns increases from the light incidence surface toward the counter surface.

6. The backlight unit of claim 4, wherein an interval between the wavelength conversion patterns in at least one of the wavelength conversion pattern columns decreases from the light incidence surface toward the counter surface.

7. The backlight unit of claim 3, wherein the wavelength conversion pattern columns are spaced apart from each other along a second direction perpendicular to the first direction.

8. The backlight unit of claim 3, wherein the scattering pattern comprises a plurality of scattering patterns spaced apart from each other,
wherein the scattering patterns are arranged along the first direction to form a plurality of scattering pattern columns.

9. The backlight unit of claim 8, wherein an arrangement density of the scattering patterns in the scattering pattern columns increases from the light incidence surface toward the counter surface.

10. The backlight unit of claim 9, wherein an area of each scattering pattern in at least one of the scattering pattern columns increases from the light incidence surface toward the counter surface.

11. The backlight unit of claim 9, wherein an interval between the scattering patterns in at least one of the scattering pattern columns decreases from the light incidence surface toward the counter surface.

12. The backlight unit of claim 8, wherein the scattering pattern columns are spaced apart from each other along a second direction perpendicular to the first direction.

13. The backlight unit of claim 8, wherein the scattering pattern columns are disposed between the wavelength conversion pattern columns.

14. The backlight unit of claim 1, further comprising a passivation layer disposed on the wavelength conversion pattern and covering the wavelength conversion pattern, wherein the scattering pattern is disposed between the light guide plate and the passivation layer.

15. The backlight unit of claim 14, wherein the scattering pattern comprises a binder and scattering particles disposed inside the binder.

16. The backlight unit of claim 14, wherein the scattering pattern is shaped as a concave pattern formed on the lower surface of the light guide plate.

17. A backlight unit, comprising:
a light guide plate;
a wavelength conversion pattern disposed on a first surface of the light guide plate;
a passivation layer disposed on the wavelength conversion pattern and covering the wavelength conversion pattern; and
a first scattering pattern which is disposed on a first surface of the passivation layer,
wherein the wavelength conversion pattern and the first scattering pattern do not overlap each other in a plan view.

18. The backlight unit of claim 17, wherein the light guide plate comprises a light incidence surface and a counter surface opposite the light incidence surface, the backlight unit further comprising a light source facing the light incidence surface, wherein the light source emits blue light.

19. The backlight unit of claim 18, wherein the wavelength conversion pattern comprises a plurality of wavelength conversion patterns spaced apart from each other, wherein the wavelength conversion patterns are arranged along a first direction to form a plurality of wavelength conversion pattern columns, the first direction is a direction from the light incidence surface toward the counter surface, and an arrangement density of the wavelength conversion patterns in the wavelength conversion pattern columns increases from the light incidence surface toward the counter surface.

20. The backlight unit of claim 19, wherein the first scattering pattern comprises a plurality of scattering patterns spaced apart from each other, wherein the scattering patterns are arranged along the first direction to form a plurality of scattering pattern columns, and an arrangement density of the scattering patterns in the scattering pattern columns increases from the light incidence surface toward the counter surface.

21. The backlight unit of claim 17, further comprising a second scattering pattern which overlaps the light guide plate, wherein at least a part of the second scattering pattern overlaps the wavelength conversion pattern in the plan view.

22. A backlight unit, comprising:
a light guide plate;
a wavelength conversion pattern disposed on a first surface of the light guide plate; and
a first scattering pattern disposed on a second surface of the light guide plate,
wherein the wavelength conversion pattern and the first scattering pattern do not overlap each other in a plan view.

23. The backlight unit of claim 22, wherein the light guide plate comprises a light incidence surface and a counter surface opposite the light incidence surface, the backlight unit further comprising a light source facing the light incidence surface, wherein the light source emits blue light.

24. The backlight unit of claim 23, wherein the wavelength conversion pattern comprises a plurality of wavelength conversion patterns spaced apart from each other, wherein the wavelength conversion patterns are arranged along a first direction to form a plurality of wavelength conversion pattern columns, the first direction is a direction from the light incidence surface toward the counter surface, and an arrangement density of the wavelength conversion patterns in the wavelength conversion pattern columns increases from the light incidence surface toward the counter surface.

25. The backlight unit of claim 24, wherein the first scattering pattern comprises a plurality of scattering patterns spaced apart from each other, wherein the scattering patterns are arranged along the first direction to form a plurality of scattering pattern columns, and an arrangement density of the scattering patterns in the scattering pattern columns increases from the light incidence surface toward the counter surface.

26. The backlight unit of claim 22, further comprising a passivation layer disposed on the wavelength conversion pattern and covering the wavelength conversion pattern.

27. The backlight unit of claim 26, wherein the first scattering pattern is shaped as a concave pattern formed on the second surface of the light guide plate.

28. The backlight unit of claim 26, wherein the first scattering pattern comprises a resin layer and a pattern portion recessed from a first surface of the resin layer.

29. The backlight unit of claim 22, further comprising a second scattering pattern which overlaps the light guide plate, wherein at least a part of the second scattering pattern overlaps the wavelength conversion pattern in the plan view.

30. A display device, comprising:
a light guide plate which comprises a first side surface, a second side surface opposite the first side surface, an upper surface connected to the first side surface and the second side surface, and a lower surface opposite the upper surface;
a wavelength conversion pattern disposed on the upper surface of the light guide plate or the lower surface of the light guide plate;
a scattering pattern disposed on the upper surface of the light guide plate or the lower surface of the light guide plate;
a light source facing the first surface; and
a display panel which overlaps the light guide plate,
wherein the wavelength conversion pattern and the scattering pattern do not overlap each other in a plan view.

31. The display of claim 30, wherein the light source emits blue light, the wavelength conversion pattern comprises first wavelength conversion particles for converting the blue light into green tight and second wavelength conversion particles for converting the blue light into red light.
